(19) United States
(12) Patent Application Publication
(10) Pub. No.: US 2016/0163403 A1
(43) Pub. Date: Jun. 9, 2016

(54) LEAD-FREE POLYMER-BASED COMPOSITE MATERIALS

(71) Applicant: Globe Composite Solutions, Ltd., Rockland, MA (US)

(72) Inventors: William O'Brien, Middleboro, MA (US); Xiujun Wang, Acton, MA (US); Carl W. Forsythe, Cohasset, MA (US); Ronald Fondren Koniz, Burdett, NY (US)

(73) Assignee: Globe Composite Solutions, Ltd., Rockland, MA (US)

(21) Appl. No.: 14/534,858

(22) Filed: Nov. 6, 2014

Related U.S. Application Data
(63) Continuation-in-part of application No. 12/570,537, filed on Sep. 30, 2009, now Pat. No. 8,940,827.
Application No. 12/570,537 is a continuation-in-part of application No. 12/357,644, filed on Jan. 22, 2009, now Pat. No. 8,487,029.
(60) Provisional application No. 61/022,611, filed on Jan. 22, 2008.

(51) Int. Cl. G21F 1/10; C08K 3/08; B65G 21/08; C08K 3/30

(52) U.S. Cl. CPC G21F 1/106; C08K 3/30; C08K 3/08; B65G 21/08; C08K 2003/3009; C08K 2003/0887

(57) ABSTRACT

The present invention relates to a lead-free, non-toxic and arc resistant composite material having a thermosetting polymer, at least one heavy particulate filler, at least one light particulate filler and, optionally, at least one arc resistant filler. The composite material may be utilized in manufacturing articles used in radiation shielding and other applications where arc resistant and dielectric strength are desired.

### CROSS-REFERENCE TO RELATED APPLICATIONS

This application is a continuation-in-part application of U.S. patent application Ser. No. 12/570,537, filed Sep. 30, 2009, entitled “Thermosetting Polymer-Based Composite Materials” which is a continuation-in-part application and claims priority to U.S. patent application Ser. No. 12/357,644, filed Jan. 22, 2009, entitled “Thermosetting Polymer-Based Composite Materials”. U.S. patent application Ser. No. 12/357,644 claims priority to U.S. Provisional Patent Application Ser. No. 61/022,611 filed Jan. 22, 2008. The foregoing patent applications are incorporated in their entireties herein.

### FIELD OF THE INVENTION

The disclosed subject matter relates to lead-free, non-toxic polymer-based composite materials, which may be used in radiation shielding, weight-balancing, ballast, or energy storage applications.

### BACKGROUND OF THE INVENTION

Lead has been used in many industries for decades. For instance, lead is widely used for radiation shielding applications due to its efficiency and low cost. While efficient and low-cost, lead has been found to be toxic to animals, and particularly toxic to humans.

In response to the desire to reduce toxicity or the use of toxic compounds, and in order to comply with state, federal, and international regulations regarding the use, transport, and disposal of lead and lead-containing composite materials, numerous lead substitutes and lead-free composite materials have been developed as replacements for lead or lead-filled composite materials. Lead substitutes and lead-free composite materials can be used in a variety of applications including, but not limited to, ammunition, construction, and radiation shielding applications.

While lead-free composite materials developed for use in radiation shielding applications thus far may offer the benefit of reduced or no toxicity, lead-free composite materials containing certain fillers in certain amounts detrimentally affect the composite material. For example, at certain levels of filler content, viscosity becomes so high that the ability to cast the material is reduced or lost completely. Some fillers also detrimentally affect the resistance to arcing and/or the dielectric strength of the composite material. A lead-free, non-toxic composite material having suitable dielectric strength and arc resistance properties and being efficient in radiation protection, economical to make and use as well as easily handled and castable or processed by other methods, such as liquid phase sintering, is desired.

Lead-vinyl radiation attenuating material used in radiation shielding strip curtains at the entrances and exits of high speed CT EDS poses a security threat to international air travel. The strips of lead-vinyl have very high friction and poor abrasion. They get caught on baggage causing the baggage to bounce, tumble and move uncontrollably relative to the Z axis of rotation of the CT scanner in the EDS. CT EDS are calibrated for movement in the Z direction but not the X or Y directions. Lead-vinyl makes baggage a “moving target”. Since the spatial position of suspect objects cannot be precisely defined, precise projection data cannot be provided to the algorithms that measure the atomic number of substances such as explosives and develop the 3D images of the contents of the baggage. This leads to false-detections and, worse, false-negative jeopardizing the security of the global air transportation system.

In addition, lead-vinyl curtains wear out quickly in high speed CT EDS. As the curtains wear TSA inspection personnel are exposed to radiation. As led-vinyl curtains wear they also deposit toxic lead dust into the air around the scanning systems and onto passenger baggage creating a serious health hazard.

The invention described in this disclosure solves all of these problems. It improves the health and safety of TSA personnel, increases the accuracy of explosive detection and increases international security.

Maintaining security of domestic and international air travel and preventing air borne terrorist attacks on the US and other countries requires screening of all airline baggage for explosives. Title 49 U.S. Code Section 44901 Screening Passengers and Property requires the “screening of all passengers and property including U.S. mail, cargo, carry-on and checked baggage operated by an air carrier or foreign air carrier in air transportation or intrastate air transportation”. The Intelligence Reform and Terrorism Prevention Act of 2004 required the Transportation Security Administration (TSA) “to take action to expedite the installation and use of in-line screening equipment . . . as required by Section 44901, 49USC and to replace explosive trace-detection equipment with explosive detection systems.”

As described in U.S. Pat. No. 7,136,450 Method of and System for Adaptive Scatter Correction in Multi-Energy Computed Tomography, Computed Tomography (CT) Explosive Detection Systems (EDS) use X-rays to measure a material's density by measuring the amount of X-ray energy absorbed by the material. In addition to measuring an objects density, the use of dual energy X-ray sources can provide additional information depending on how the instrument is calibrated. At one calibration setting the effective atomic number Z can be measured. At other calibration settings the material's photoelectric coefficients or Compton coefficients can be measured. Settings can also be chosen so as to tell the amount of two different materials present such as plastic and aluminum. As described in U.S. Pat. No. 4,029,963 X-ray Spectral Decomposition Imaging System a computer is used to process algorithms, such as the Alvarez-Macovski Algorithm (AMA), to combine projection measurements of the transmitted x-ray beam in low and high energy regions to produce atomic-number-dependent and density-dependent projection data and provide cross sectional, tomographic images that completely define the specific material properties. The tomographic images, virtual slices, are then combined to create a three dimensional image.

The precise calibration required for a CT EDS to accurately measure the density, atomic number, photoelectric coefficients, Compton coefficients and amounts of different materials present inside baggage requires that individual pieces of baggage pass separately through the coordinate system of the scanner in a stable position relative to the X, Y and Z axes of the scanner. The axes intersect and are all normal to one another at the center of rotation of the CT scanner. The Z axis defines the center of rotation of the system. Movement in the Z direction is required at constant predetermined velocity. Movement in the X or Y direction or in the Z direction at non constant velocity prevents accurate detection of explosives.

As described in U.S. Pat. No. 7,136,450 when in operation the scanner continuously rotates around the Z axis. X-rays emanate from the source, pass through a piece of baggage located on a conveyor running through the opening of the scanner and strike the detector array positioned diametrically opposite the X-ray source.

Alternative arrangements using several different fixed X-ray sources and fixed detector arrays could also be used in EDS and are still within the scope of this invention. EDS with a stationary gantry and no moving parts in the gantry, such as the L3 Security and Detection MV3D would also fall within the scope of this invention.

A schematic diagram of a portion of an EDS taken from U.S. Pat. No. 7,962,650 Method of and System for 3D Display of Multi-Energy Computed Tomography Images is shown in FIG. 1.

The radiation shielding curtains at the entrance and exit of the CT EDS system are not shown.

In FIG. 1 the baggage conveyor system 110 composed in this example of a plurality of individual conveyor systems 122 runs from left to right. The flow of baggage 112 through the CT scanning system is from left to right in the direction shown by arrow 114. A coordinate system has been added to the upper left of FIG. 1. The direction of flow of the baggage 114 is parallel to Z axis of the coordinate system.

The CT scanning system 120 is housed in the centrally located gantry 125. Inside the gantry are an X-ray tube 128, a detector array 130, and primary/direct X-ray radiation shields 138 positioned “behind”/distal to the detector array 130. The center of rotation of the disk 124 defined by the X-ray tube 128 and the detector array 130 and primary shields 138 positioned diametrically opposite from the X-ray tube is also parallel to the Z axis and to the direction of flow of the baggage. Also shown is a very narrow portion of the pyramid-shaped X-ray “cone beam” 132 emanating from the X-ray source 128. Very importantly, portions of the X-ray “cone beam” 132 project obliquely (not shown) through the openings in the gantry 125 through which the conveyor system 122 passes carrying the baggage 112.

The detector array 130 can receive X-rays directly from the X-ray tube 128 and X-rays attenuated by the density of objects in the baggage. It also receives X-rays that are scattered from the baggage being inspected, the side walls of the gantry 125, the conveyor 122, and the inner surfaces of radiation shielding curtains such as those shown in FIG. 2. The CT EDS system is calibrated to account for these types of controlled scatter. It is also calibrated for baggage lying flat on a conveyor moving at constant speed with a constant orientation relative to the X, Y and Z coordinates of the system. The baggage shown in FIG. 1 is all aligned at 0 degrees which is defined as when the long axis of the baggage is parallel to the Z axis of the system, in other words, parallel to the direction of flow of the conveyor and axis of rotation of the CT scanner disk 124. The CT system is calibrated to also account for baggage which may be positioned at 90 degrees relative to the Z axis or at 45 degrees or at any other angle. Critical for accurate detection of explosives is that the data received by the detector array must be precise. The spatial location of the object interacting with the X-ray beam must be precisely defined for accurate detection of explosives.

As long as a piece of baggage moves through the X-ray cone beam 132 in a fixed position relative to the coordinate system, and at a fixed velocity, scatter can be accounted for and precise atomic-number-dependent and density-dependent projection data can be passed from the detector array 130 to the data acquisition system 134 and processed by computer using, for example, the AMA, to provide accurate cross sectional, tomographic images that completely define the specific material properties. These virtual slices can then be combined into an accurate 3D image color coded to show potential threats and accurately identify explosives.

If, however, the baggage is moving in either or both the X or Y directions relative to the coordinate system or in the Z direction at a velocity faster or slower than the programmed conveyor velocity when it passes through the X-ray cone beam then the spatial position of the substance interacting with the X-ray cannot be precisely defined and precise data cannot be generated. In these cases accurate detection of explosives is not possible.

Since accurate detection is not possible false-detections and false-negative can result. False-detections result when the EDS detects an explosive when none is present. These require the suspect bag to be routed to the TSA Checked Baggage Resolution Area (CBRA) for costly, time-consuming hand inspection of the baggage. If the bag cannot be cleared in time for the flight it can cost the airline $100-$150 per bag to deliver it to the appropriate destination. False-negatives, failing to detect an explosive when one is present, can lead to catastrophe and threaten national security.

In addition to mis-reads, false-detects and false-negatives caused by improperly functioning radiation shielding curtains as described above, improperly functioning radiation shielding curtains can allow radiation to “leak” out of the inspection system creating a hazard for TSA inspectors, other personnel and any passengers near the EDS or X-ray inspection system.

The US Code of Federal Regulations set limits on the amount exposure permitted: 21CFR1020.40(c)(1)(i) “Performance Standards for Ionizing Radiation, Cabinet x-ray systems, (c) Requirements—(1) Emission limit (i) Radiation emitted from the cabinet x-ray system shall not exceed 0.5 milliroentgen in one hour at any point five centimeters outside of the external surface.” The radiation must be measured under conditions which (ii) “produce the maximum x-ray exposure at the external surface”. This includes measuring the radiation while the X-ray inspection system or EDS is fully operational with baggage passing through it.

In order to provide radiation shielding to protect passengers, other personnel and inspectors from radiation several solutions have been described. See for example: U.S. Pat. No. 3,980,889 Article Transfer and Inspection Apparatus; U.S. Pat. No. 4,581,538 Radiation Shield; U.S. Pat. No. 4,977,585 Self-Shielded Computerized Tomographic Scanner; U.S. Pat. No. 6,278,125 Shielded Radiation Assembly and U.S. Pat. No. 7,667,215 Method and Apparatus for Providing Radiation Shielding for Non-Invasive Inspection Systems.

The radiation shielding described in the patents cited above all use flexible “slats” of radiation shielding material. U.S. Pat. No. 7,667,215 defines a “slat” as a “thin piece of radiation attenuating material having a length greater than its width”. FIG. 2 shows an arrangement of eight radiation shielding strip curtains (401-408) each composed of 16 slats of radiation attenuating material.

Although other possible radiation attenuating materials have been disclosed the predominant material currently used in all x-ray inspection and high speed CT EDS (CTX) is “lead-vinyl” defined as polyvinyl chloride containing plasticizer and lead powder or lead oxide. Lead-vinyl that is used in CT EDS systems is a national security threat.

There are two problems with radiation shielding strip curtains constructed of slats made with lead-vinyl. First, lead-vinyl has a high coefficient or friction. Second lead-vinyl has very poor abrasion resistance. As noted above the strips of lead-vinyl get caught on baggage causing the baggage to bounce, tumble and move uncontrollably relative to the Z axis of rotation of the CT scanner in the EDS.

“Coefficient of friction or μ” is defined as the ratio of the force that maintains contact between an object and a surface and the frictional force that resists the motion of the object. Because lead-vinyl has a high μ, slats made of lead-vinyl experience high friction when baggage moving on the conveyor contacts the slats while passing through the EDS.

Abrasion resistance is determined by measuring the volume of material lost from a sample while in contact with a moving cylinder covered by a sand paper like material for a defined distance at a defined pressure. The higher the volume of material lost the lower the abrasion resistance. The lower the abrasion resistance that worse the performance and the faster the lead-vinyl material wears out, losing toxic lead dust in the process.

Because lead itself has a very low resistance to indentation as measured by its Brinell hardness (0.0375-0.0418 GPa) and very poor scratch resistance as measured by its Mohs Hardness (1.5), lead-vinyl will demonstrate similarly poor hardness and scratch resistance.

The high friction of lead-vinyl causes increased abrasion of the lead-vinyl material. Since lead-vinyl is neither hard nor scratch resistant, the abrasion caused by irregularly shaped baggage can be very inhomogeneous. This inhomogeneity results in an uneven surface of the lead-vinyl which leads to even higher friction and greater propensity for abrasion. The higher friction and abrasion result in worn and missing radiation shielding curtain slats leading to increased radiation exposure, baggage jams and some very unsafe practices to clear the jams as documented in a CDC NIOSH evaluation of TSA workers to radiation exposure and shown in FIG. 3.

Because of the high coefficient of friction of lead-vinyl it is frequently coated with PTFE (Teflon®) film to decrease the coefficient of friction. Since lead-vinyl is inherently weak it is frequently reinforced by molding a fabric scrim into the center of the material sandwiched between two layers of lead-vinyl.

Testing in accordance with (IAW) ASTM D1894-14 sows that Teflon® coated lead vinyl has a high static coefficient of friction of ˜0.65 and a high dynamic coefficient of friction of ˜0.73.

Abrasion resistance testing IAW ASTM D 5963-04 demonstrates that Teflon® coated lead-vinyl has poor abrasion resistance losing 503 mm³ of material and actually falling apart before the test was complete.

The need to increase the throughput of checked baggage at major airports has led all three of the major global manufacturers of high speed EDS; Smiths Detection, Morpho and L3 Security and Detection to develop high speed EDS capable of scanning 1800 bags per hour at a velocity of 0.5 m/s, 98.5 ft/min. These systems are shown in FIG. 4. FIG. 5 shows a schematic visualization of a high-throughput in-line baggage handling system employing explosive detection systems

The high speed increases the momentum of baggage striking the radiation shielding curtains causing even more wear on the lead-vinyl curtains. Because of the worn, abraded lead-vinyl curtains all three major manufacturers of EDS have experienced radiation leakage levels above those limit set by 21CFR 1020.40 and bag mis-tracks, mis-reads and false detections caused by among other factors inconsistent scatter impinging on the detector arrays (see U.S. Pat. No. 7,136,450 Method and System for Adaptive Scatter Correction in Multi-Energy Computer Tomography.)

### SUMMARY OF THE INVENTION

We have invented a novel solution to the problems described above caused by the use of lead-vinyl radiation attenuating slats in radiation shielding in X-ray baggage scanners and high speed CT Explosive Detection Systems.

One aspect of the disclosed subject matter relates to a lead-free, non-toxic composite material. This composite material comprises a thermosetting polymer; at least one filler selected from a first group consisting of heavy particulate fillers; at least one filler selected from a second group consisting of light particulate fillers; wherein the thermosetting polymer includes one selected from epoxy resins, urethane prepolymers, phenolics, silicones, unsaturated esters, vinyl esters and melamines; wherein the heavy particulate filler is selected from a first group consisting of tungsten, osmium, uranium, iridium, platinum, gold, molybdenum, tantalum, hafnium, thallium, palladium, ruthenium, rhodium, silver and combinations thereof; wherein the light particulate filler is selected from a second group consisting of barium, barium sulfate, barium carbonate, barium hydroxide, barium oxide, tin, tin oxide, tin dioxide, bismuth, bismuth oxide, copper, copper oxide, iodine, zirconium, zirconium dioxide, nickel, nickel oxide, and combinations thereof.

Another aspect relates to a lead-free, non-toxic article comprising a lead-free, non-toxic composite material. This composite material comprises a thermosetting polymer; at least one filler selected from the first group consisting of heavy particulate fillers, and at least one filler selected from the second group consisting of light particulate fillers; wherein the thermosetting polymer includes one selected from epoxy resins, urethane prepolymers, phenolics, silicones, unsaturated esters, vinyl esters and melamines; wherein the heavy particulate filler is selected from the first group consisting of tungsten, osmium, uranium, iridium, platinum, gold, molybdenum, tantalum, hafnium, thallium, palladium, ruthenium, rhodium, silver and combinations thereof and further wherein the light particulate filler is selected from the second group consisting of barium, barium sulfate, barium carbonate, barium hydroxide, barium oxide, tin, tin oxide, tin dioxide, bismuth, bismuth oxide, copper, copper oxide, iodine, zirconium, zirconium dioxide, nickel, nickel oxide, and combinations thereof.

Another aspect relates to a method of dispensing and/or manufacturing lead-free, non-toxic radiation shielding devices, such as radiation shielding devices for radioactive isotopes of Xenon, Xe-133, Technetium, Tc-99m, Gallium Citrate, Ga-67, Samarium, Sm-153, Thallium Chloride, TI-201 and the like. This method comprises combining a liquid thermosetting polymer, at least one filler selected from the first group consisting of heavy particulate fillers, and at least one filler selected from the second group consisting of light particulate fillers to form a lead-free, non-toxic composite material, wherein the thermosetting polymer includes one selected from epoxy resins, urethane prepolymers, phenolics, silicones, unsaturated esters, vinyl esters and melamines; wherein the heavy particulate filler is selected from the first group consisting of tungsten, osmium, uranium, iridium, platinum, gold, molybdenum, tantalum, hafnium, thallium, palladium, ruthenium, rhodium, silver and combinations thereof; and wherein said light particulate filler is selected from the group consisting of barium, barium sulfate, barium carbonate, barium hydroxide, barium oxide, tin, tin oxide, tin dioxide, bismuth, bismuth oxide, copper, copper oxide, iodine, zirconium, zirconium dioxide, nickel, nickel oxide, and combinations thereof; and casting the lead-free, non-toxic composite material to form a lead-free, non-toxic article.

Another aspect relates to a method of manufacturing a lead-free, non-toxic X-ray and/or Gamma-ray radiation shielding device exhibiting arc resistance and suitable dielectric strength. This method comprises combining a liquid thermosetting polymer, at least one filler selected from the first group consisting of heavy particulate fillers, at least one filler selected from the second group consisting of light particulate fillers, at least one filler selected from the third group consisting of arc resistant fillers and combinations thereof to form a lead-free, non-toxic, and arc resistant composite material, wherein the heavy particulate filler is selected from the first group consisting of tungsten, osmium, uranium, iridium, platinum, gold, molybdenum, tantalum, hafnium, thallium, palladium, ruthenium, rhodium, silver; wherein the light particulate filler is selected from the second group consisting of barium, barium sulfate, barium carbonate, barium hydroxide, barium oxide, tin, tin oxide, tin dioxide, bismuth, bismuth oxide, copper, copper oxide, iodine, zirconium, zirconium dioxide, nickel, nickel oxide, and combinations thereof; and further wherein the arc resistant filler is selected from the group consisting of boron nitride, boron oxide, zinc oxide, aluminum oxide, titanium oxide, magnesium oxide, iron oxide and combinations thereof; and casting the lead-free, non-toxic composite material to form a lead-free, non-toxic and arc resistant X-ray and/or Gamma ray radiation shielding device.

Yet a further aspect relates to a method of manufacturing a lead-free, non-toxic radiation shielding device, such as radiation shielding devices for radioactive isotopes of zenon, Xe-133, Technetium, Tc-99m, Gallium Citrate, Ga-67, Samarium, Sm-153, Thallium Chloride, TI-201 and the like. This method comprises combining a solid thermosetting polymer, at least one heavy particulate filler and at least one light particulate and combinations thereof to form a lead-free, non-toxic composite material, wherein the heavy particulate filler is selected from a group consisting of tungsten, osmium, uranium, iridium, platinum, gold, molybdenum, tantalum, hafnium, thallium, palladium, ruthenium, rhodium, silver and combinations thereof and further wherein said light particulate filler is selected from the group consisting of barium, barium sulfate, barium carbonate, barium hydroxide, barium oxide, tin, tin oxide, tin dioxide, bismuth, bismuth oxide, copper, copper oxide, iodine, zirconium, zirconium dioxide, nickel, nickel oxide, and combinations thereof; and a liquid phase sintering process the lead-free, non-toxic composite material to form a lead-free, non-toxic radiation shielding article.

Yet a further aspect relates to a method of manufacturing a lead-free, non-toxic radiation X-ray and/or Gamma ray shielding device in which arc resistance and dielectric strength are important. This method comprises combining a solid thermosetting polymer, at least one heavy particulate filler, at least one light particulate, and at least one arc resistant filler and combinations thereof to form a lead-free, non-toxic composite material, wherein the heavy particulate filler is selected from the first group consisting of tungsten, osmium, uranium, iridium, platinum, gold, molybdenum, tantalum, and combinations thereof; wherein the light particulate filler is selected from the second group consisting of barium, barium sulfate, barium carbonate, barium hydroxide, barium oxide, tin, tin oxide, tin dioxide, bismuth, bismuth oxide, copper, copper oxide, iodine, zirconium, zirconium dioxide, nickel, nickel oxide, and combinations thereof; and wherein the arc resistant filler is selected from the group consisting of boron nitride, boron oxide, zinc oxide, aluminum oxide, titanium oxide, magnesium oxide, iron oxide and combinations thereof; and the liquid phase sintering process, the lead-free, non-toxic composite material to form a lead-free, non-toxic and arc resistant X-ray and/or Gamma ray article.

Yet a further aspect relates to a lead-free, non-toxic composite material, the composite material comprising a thermosetting polymer; a heavy particulate filler comprising a metal; and a light particulate filler, the light particulate filler having a specific gravity that is less than a specific gravity of the heavy particulate filler.

A further aspect relates to a lead-free, non-toxic composite material. This composite material comprises a thermosetting polymer; a heavy particulate filler comprising a metal; a light particulate filler, the light particulate filler having a specific gravity that is less than a specific gravity of the heavy particulate filler; and an arc resistant filler comprising at least one of a metal nitride, a metalloid nitride, a metal oxide, and a metalloid oxide.

A lead-free, non-toxic composite material may also, more specifically, comprise an epoxy resin; a heavy particulate filler comprising tungsten; a light particulate filler comprising barium sulfate; and an arc resistant filler comprising at least one of a metal nitride, and a metalloid nitride, a metal oxide, and a metalloid oxide.

A further aspect relates to a method of manufacturing a lead-free, non-toxic radioactive isotope radiation shielding device. This method comprises the steps of combining a liquid thermosetting polymer, at least one heavy particulate filler selected from a first group consisting of heavy particulate fillers, and at least one light particulate filler selected from a second group consisting of light particulate fillers and combinations thereof to form a lead-free, non-toxic composite material; and casting the lead-free, non-toxic composite material to form a lead-free, non-toxic article.

Still another aspect relates to a method of manufacturing a lead-free, non-toxic radioactive isotope radiation shielding device, this method comprising the steps of combining a solid thermosetting polymer, at least one heavy particulate filler selected from a first group consisting of heavy particulate fillers, and at least one light particulate filler selected from a second group consisting of light particulate fillers and combinations thereof to form a lead-free, non-toxic composite material; and liquid phase sintering the lead-free, non-toxic composite material to form a lead-free, non-toxic article.

The present invention provides high density composite compositions that may be used for replacement of lead or lead filled composite materials for other applications which include, but are not limited to, counterweights, acoustic dampening materials, energy storage, and the like.

The present invention also provides an efficient means of improving arc resistance, dielectric strength, dielectric constant, dissipation factor, and electrical resistivity for composite materials comprising tungsten element powder and a thermoplastic resin as a binder, which includes, not limited to, polyamide, polyester, polyethylene, polypropylene, poly-1-butene, polyisobutylene, polystyrene, acrylonitrile-butadiene-styrene block copolymer, polyvinyl chloride, polyurethane, polyurea, ethylene-vinyl acetate copolymer, ethylene-propylene copolymer, ionomer, fluoro-polymer, polysulfone, polyphenylene oxide, polycarbonate, acetal, polyphenylene sulfide, polyacrylate, polyetherimide, polyetheretherketone, polyimide, polyamideimide and the like.

One embodiment of the present disclosure relates to novel, surprisingly low coefficient of friction and self-lubricating composites that are highly durable, flexible and radiation attenuating. Another embodiment describes a method and mechanism using these composites to increase the precision and accuracy of high energy inspection systems such as high speed computed tomography explosive detection systems (CT EDS) resulting in better detection of explosives to prevent them from being carried in checked baggage on commercial airliners. The novel radiation attenuating composites are used to manufacture radiation shielding strip curtains positioned at the entrances and exits of CT EDS to eliminate movement of baggage orthogonal to the axis of rotation of the CT scanner, decrease radiation exposure of TSA personnel and eliminate exposure of TSA personnel and passengers to toxic lead dust.

Another embodiment disclosed herein is a radiation barrier for a system used to inspect goods moving along a conveyor, the radiation barrier comprising: a flexible elongated strip to be affixed at its upper end above the conveyor, said strip consisting of: a thermoplastic polymer; particles of tungsten suspended throughout said polymer in sufficient quantities to provide a radiation barrier; and sufficient quantities of tungsten disulfide to provide self-lubricating properties, said flexible elongated strip substantially reducing the passage of radiation while having sufficient wear resistance to reduce erosion of its surface and having sufficient flexibility and coefficient of friction to reduce displacement of the conveyed goods in directions lateral to the movement of the conveyor.

A further embodiment disclosed herein is a radiation barrier for a system used to inspect goods moving along a conveyor, the radiation barrier comprising: a flexible elongated strip to be affixed at its upper end above the conveyor, said strip consisting of: a thermosetting polymer; particles of tungsten suspended throughout said polymer in sufficient quantities to provide a radiation barrier; and sufficient quantities of tungsten disulfide to provide self-lubricating properties, said flexible elongated strip substantially reducing the passage of radiation while having sufficient wear resistance to reduce erosion of its surface and having sufficient flexibility and coefficient of friction to reduce displacement of the conveyed goods in directions lateral to the movement of the conveyor.

The above described and other features are exemplified by the following detailed description.

### BRIEF DESCRIPTION OF THE DRAWINGS

FIG. 1: Schematic drawing taken from U.S. Pat. No. 7,962,650 showing portions of an Explosive Detection System including the baggage conveyor system. A coordinate system has been added to the upper left of the diagram.

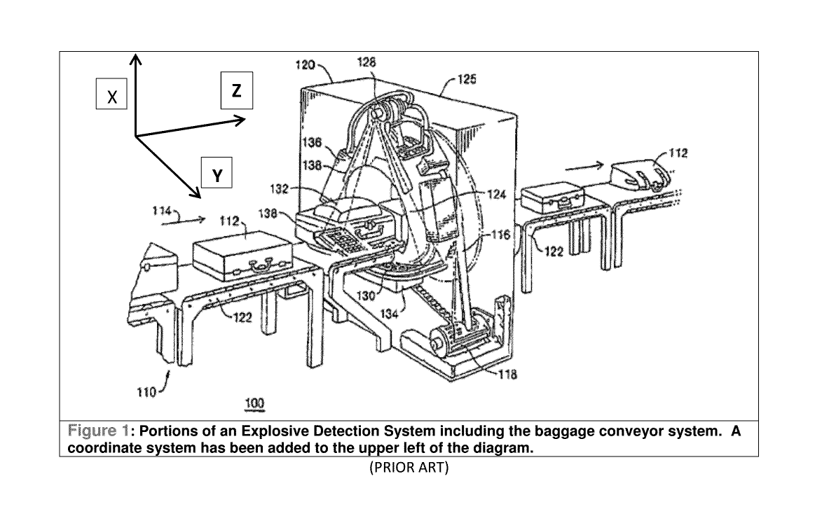

FIG. 2: Perspective view taken from U.S. Pat. No. 7,667,215 showing an arrangement of radiation shielding strip curtains (401-408) each composed of slats 414 of radiation attenuating material.

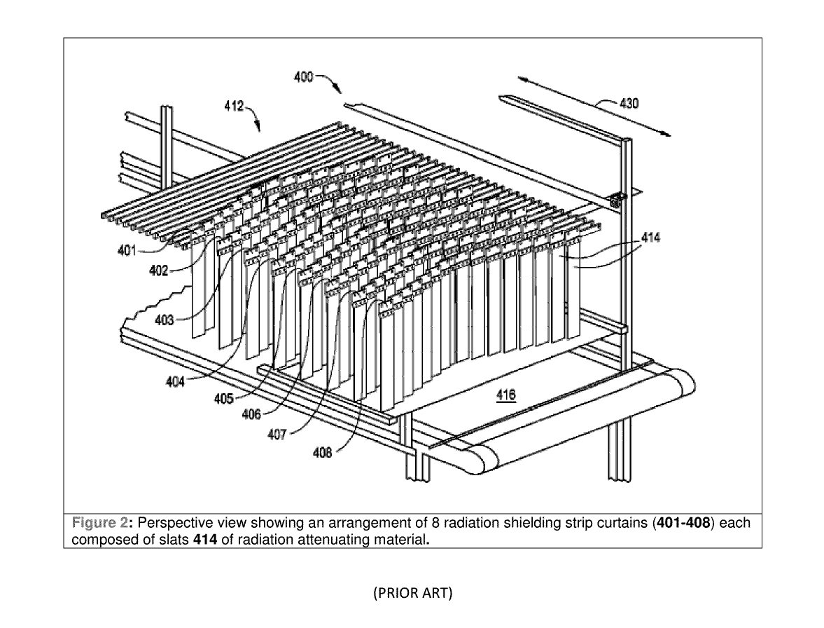

FIG. 3: CDC NIOSH: Evaluation of Radiation Exposure to TSA Baggage Screeners

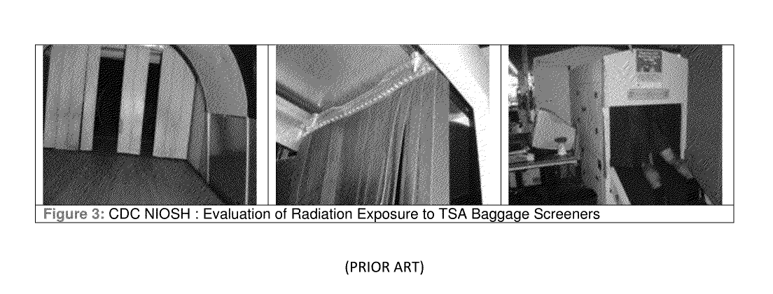

FIG. 4: High Speed Explosive Detection Systems of three of the largest global manufacturers of EDS

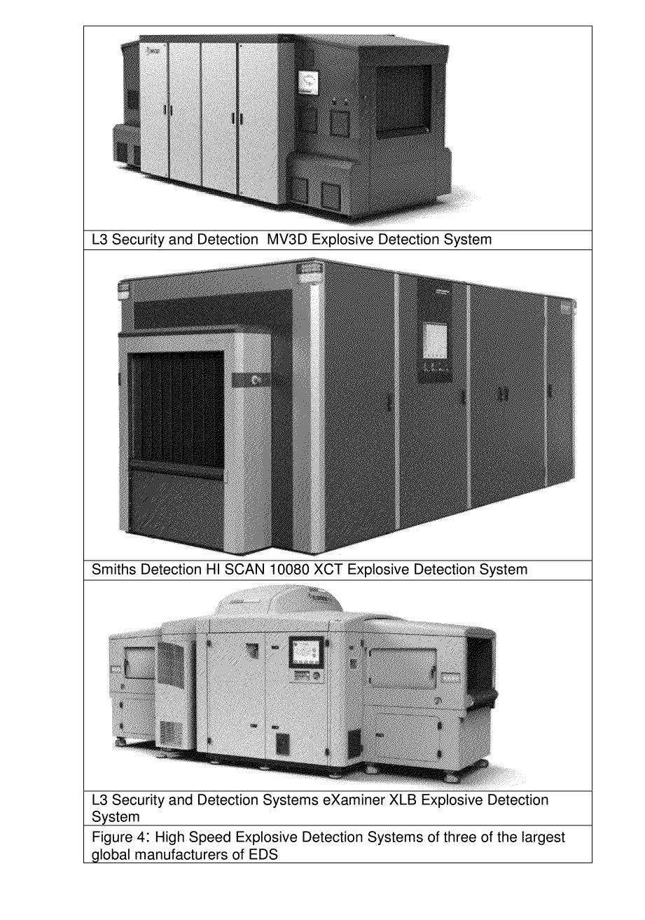

FIG. 5: Schematic visualization of a high-throughput in-line baggage handling system employing explosive detection systems (TSA PGDS)

FIG. 6: Coefficients of friction Teflon® coated lead-vinyl and

FIG. 7: Radiation shielding effectiveness of material made according to Example 1, a 0.5 mm lead equivalent lead-vinyl, and 2.8 mm solid lead sheet. Density of X-ray exposed Fuji 100 film at 85 sec exposure, with the X-ray source 53 inches from the film.

FIG. 8: Taber stiffness gf-cm to bend sample 15 degrees

FIG. 9: Rotary drum abrasion, ASTM D 5963 showing that the material of Example 1 resists abrasion 3X better than Teflon® coated lead vinyl

FIG. 10: Particle sizes of tungsten powder which could be used in the invention

FIG. 11: Drawing of mold designed to manufacture sections of the strip curtains used in an EDS

FIG. 12: Bag emerging from a high speed EDS at a 0 degree

### DETAILED DESCRIPTION

One embodiment of the disclosed composite material includes a thermosetting polymer, at least one heavy particulate filler selected from the first group consisting of heavy particulate fillers and at least one light particulate filler selected from the second group consisting of light particulate fillers or a combination thereof. The terms “heavy” and “light” refer to the specific gravity of the particulate fillers. In general, heavy particulate filler has a higher relative specific gravity than a light particulate filler. It is also envisioned that an embodiment of the disclosed composite material includes a thermosetting polymer and at least one heavy particulate filler or at least one light particulate filler. It is also envisioned that in any embodiment disclosed herein the thermosetting polymer can be replaced with a thermoplastic polymer.

Another embodiment of the disclosed composite material includes a thermosetting polymer, at least one heavy particulate filler selected from the first group consisting of heavy particulate fillers, at least one light particulate filler selected from the second group consisting of light particulate fillers, and at least one arc resistant filler selected from the third group consisting of arc resistant fillers or combinations thereof.

In a particular embodiment, the composite material comprises tungsten powder, barium sulfate powder, and an epoxy resin as a binder.

In another embodiment, the composite material comprises tungsten powder, barium sulfate powder, boron nitride powder, and an epoxy resin as a binder.

In another embodiment, the composite material comprises tungsten powder, barium sulfate powder, zinc oxide powder, and an epoxy resin as a binder.

In another embodiment, the composite material comprises tungsten powder, barium sulfate powder, boron nitride powder and zinc oxide powder, and an epoxy resin as a binder.

A novel aspect of the present invention is the use of a dual-filler composite composition, which may be used in the fabrication of an article such as a radiation shield device or a radiation shield container. One exemplary dual-filler composition consists of tungsten powder and barium sulfate powder. Tungsten has a specific gravity of 19.35, barium sulfate's specific gravity is 4.5, and the specific gravity of liquid epoxy resin before being cured (solid) is about 1.1 to about 1.2. When tungsten powder alone is added to a liquid epoxy resin, tungsten has a tendency to settle in the liquid epoxy resin due to differences between the specific gravities of tungsten and the liquid epoxy resin. As a result, the formed article may have a different density distribution. For example, a top portion of the article may have a lower specific gravity than a bottom portion of the same article. Subsequently, the article will exhibit different performance aspects from the top to the bottom of the article.

There are several advantages for the dual-filler compositions. First, barium sulfate desirably helps reduce the tendency for tungsten powder to settle when it is introduced into the above compositions. This is primarily because barium sulfate has a lower specific gravity, a greater specific surface area (surface area/gram), and a higher aspect ratio (length/diameter) than tungsten. Barium sulfate powder also affects rheological properties of the composite compositions. As a result, the use of barium sulfate can modify rheological properties/viscosities of the composite composition, reduce settling of tungsten powder, and make cured articles with more uniform distribution of density.

Second, barium sulfate has suitable radiation-blocking material due to the fact that barium has a relatively large atomic number, 56.

Third, barium sulfate has a higher value of electrical resistivity than tungsten, so that barium sulfate provides improved dielectrical strength and arc resistance.

Furthermore, the use of barium sulfate provides a suitable means to control the composite material's specific gravities, particularly for specific gravities less than 3.00.

Additionally, barium sulfate is a cost-effective radiation shielding material. Tungsten is relatively expensive. It is advantageous to use barium sulfate in the composite compositions to reduce the overall material cost.

The composite material may be lead-free, non-toxic, and possess radiation shielding capabilities covering a broad range of radioactive isotope radiation shielding levels from 80 KeV for Xe-133 up to 320 KeV for Ga-67. The intermediate radiation shielding levels include 100 KeV for Sm-153, and 160 KeV for Tc-99m.

The composite material may also be lead-free, non-toxic, and possess radiation shielding covering X-ray and Gamma-ray radiation shielding levels from as low as 5 peak kilovolt (5kVp) to as high as about 300 peak kilovolt (300 kVp) when the composite material is used to structure X-ray and Gamma-ray devices or containers.

Another novel aspect of the present invention is the development of the arc resistant composite compositions which are applicable for creating X-ray and Gamma-ray shielding devices where arc resistance and dielectric strength are desired. While not wanting to be bound by a particular theory, arc resistance makes it possible to make direct shielding for x-ray tubes from tungsten based composites. One of the compositions consists of tungsten powder, barium sulfate powder, and boron nitride powder or zinc oxide or the combination of the two, where boron nitride powder or zinc oxide or the combination of the two improves the arc resistance.

Table 1 below shows comparison of dielectric strength of three composite materials that have approximately the same specific gravity. Sample 1 is filled with barium sulfate powder, and Sample 2 is filled with 30% wt tungsten powder and 45% wt barium sulfate powder. Sample 3 is filled with lead and lead tetraoxide powder. For all of the three composite materials, epoxy resin is used as a binder material.

TABLE 1
Comparison of dielectric strength

| | | | | Dielectric |
|---|---|---|---|---|
| Sam- | Specific | Total filler | Individual filler | strength, |
| ple | gravity | wt % | wt % | V/mil |
| 1 | 2.6 | 75% wt | 75% wt barium sulfate | 384 |
| 2 | 3.0 | 75% wt | 30% wt tungsten & | 130 |
| | | | 45% wt barium sulfate | |
| 3 | 2.92 | n/a | Lead & lead tetraoxide | 299 |

Table 1 indicates that the barium sulfate filled composite material (Sample 1) has desirable dielectric strength. This is why barium sulfate is used in the dual-filler compositions. The dielectric strength tests were carried out according to ASTM D 149-97a Method A by Plastics Technology Laboratories, Pittsfield, Mass.

Table 2 below shows a comparison of arc resistance of two composite materials that have approximately the same specific gravity, one of which is filled with tungsten powder and barium sulfate powder and the other of which is filled with tungsten powder, barium sulfate powder, and zinc oxide powder. For both composite materials, epoxy resin is used as a binder material.

TABLE 2
Comparison of arc resistance

| | | | | Arc resis- |
|---|---|---|---|---|
| Sam- | Specific | Total filler | Individual filler | tance per |
| ple | gravity | content | content | ASTM D 497 |
| 4 | 3.635 | 77.28% wt | 50% wt tungsten | 23 seconds |
| | | | 27.5% wt barium sulfate | |
| 5 | 3.4 | 78.0% wt | 39% wt tungsten | 146 seconds |
| | | | 22%% wt barium sulfate | |
| | | | 17.5% wt zinc oxide | |

Table 2 demonstrates that substitution of 11% wt tungsten powder and 5.5 wt % barium sulfate with zinc oxide powder substantially improves arc resistance of the composite material while maintain the same specific gravity and radiation shielding capacity. The arc resistance tests were carried out according to ASTM D 495 & UL 746A High Voltage, Low Current, Dry Arc Resistance by ELTEK International Laboratories, St. Charles, Mo.

Table 3 below shows a comparison of arc resistance of three composite materials that have approximately the same specific gravity, one of which is filled with tungsten powder and barium sulfate powder; the second of which is filled with tungsten powder, barium sulfate powder, and zinc oxide powder; and third of which is filled with tungsten powder, barium sulfate powder, and the combination of zinc oxide powder and boron nitride powder.

TABLE 3
Comparison of arc resistance

| | | | | Arc resis- |
|---|---|---|---|---|
| Sam- | Specific | Total filler | Individual filler | tance per |
| ple | gravity | content | content | ASTM D 495 |
| 4 | 3.635 | 77.50% wt | 50% wt tungsten & | 23 seconds |
| | | | 27.5% wt barium sulfate | |
| 6 | 3.4 | 78.5% wt | 39% wt tungsten | 146 seconds |
| | | | 22% % wt barium sulfate | |
| | | | 17.5% wt zinc oxide | |
| 5 | 3.4 | 79.0% wt | 40% wt tungsten | 182 seconds |
| | | | 22% % wt barium sulfate | |
| | | | 14.5% wt zinc oxide | |
| | | | 2.5% wt boron nitride | |

It is apparent that substituting 2.5 wt % zinc oxide powder with boron nitride powder further improves arc resistance of the composite material by about 25%. The arc resistance tests were carried out according to ASTM D 495 & UL 746A High Voltage, Low Current, Dry Arc Resistance by ELTEK International Laboratories, St. Charles, Mo.

As was discovered, two composite materials having approximately the same specific gravity may have equivalent radiation shielding performance when exposed to a relatively low radiation energy level, such as a 76 kVp X-ray radiation source. Therefore, to shield a relatively low level of radiation energy, it may be advantageous to use a lower amount of tungsten and greater amount of barium sulfate along with an arc resistant filler to produce a composite material with approximately the same specific gravity. This is one method of increasing arc resistance.

Furthermore, the composite material may have a high specific gravity. The specific gravity may be between, for example, 1.5 and 12. In one example, the composite material may have a specific gravity between 1.5 and 3.0. In another example, the composite material may have a specific gravity between 3.0 and 6.0. In yet a further example, the composite material may have a specific gravity between 3.0 and 5.0. In yet another example, the composite material may have a specific gravity between 2.5 and 6.0. In a further example, the composite material may have a specific gravity between 2.0 and 4.5. In yet another example, the composite material may have a specific gravity between 2.5 and 12.

It has been found that the rate of radiation transmission passing through a composite material is reduced inversely to the density of the composite material. The composite material may be used in a variety of manners and applications, including, but not limited to, being cast as a radiation shield device or a radiation shield container, and as a radiation shield, applied to objects as a shielding layer, such as garments or applied to objects, such as a coating.

The thermosetting polymer may be any thermosetting polymer known in the art. Thermosetting polymers in composite materials are often referred to as a matrix or a binder. Examples of thermosetting polymers include polymer materials that irreversibly cure to a stronger form. The cure may be accomplished through heat (generally at around 200 degrees Celsius), through a chemical reaction (two-part epoxy, for example), or irradiation such as electron beam processing. Specific examples of thermosetting polymers include, but are not limited to, epoxy resins, urethane prepolymers, phenolics, silicones, unsaturated esters, vinyl esters, melamines, and combinations thereof.

In one example of the composite material, the thermosetting polymer is an epoxy resin. The epoxy resin may be in liquid or solid form. If in liquid form, the composite material is able to be poured or cast by a casting technique. If, however, the epoxy resin is in solid form, the composite material may be processed by a liquid phase sintering process, where the thermosetting polymer, premixed with the fillers, is melted, pressurized, and followed by a curing process.

The epoxy resin used in the composite material may have an epoxide equivalent weight in the range of 100 to 590, and a viscosity in the range of 40 poises to 250 poises. In another example, the epoxy resin has a viscosity in the range of 60 poises to 200 poises. In yet another example, the viscosity of the epoxy resin is between 80 poises to 170 poises.

In one example, the epoxy resin has low molecular weight. The epoxy resin may also have outstanding resistance to pigment and filler settling. Resistance to pigment and filler settling allow for a uniform dispersion of the fillers and pigments present in the composite material. The epoxy resin may also have superior resistance to foaming under vacuum. Specific examples of liquid epoxy resins include, but are not limited to the diglycidyl ether of Bisphenol A, available as Epon™ 8280 epoxy resin and the diglycidyl ether of Bisphenol F, which is available as Epon™ 862 epoxy resin, both available from Hexion Specialty Chemicals, Columbus, Ohio, United States. A specific example of a solid epoxy resin is the diglycidyl ether of Bisphenol A Epon™ 3002, also available from Hexion Specialty Chemicals, Columbus, Ohio, United States.

In one example, the composite material includes between 0.5% and 50% by weight of epoxy resin, based on the weight of the composite material. In another example, the composite material includes between 10% and 50% by weight of epoxy resin, based on the weight of the composite material. In yet a further example, the composite material includes between 0.5% and 30% by weight of epoxy resin, based on the weight of the composite material.

In another example of the composite material, the thermosetting polymer is a urethane. Typically, the urethane is in liquid form, thereby allowing the composite material to be pourable or castable. The urethane may be a low viscosity urethane. In yet another example of the composite material, the thermosetting polymer is a urethane prepolymer having a pot life greater than 5 minutes. In another example, the pot life of the urethane prepolymer has a pot life greater than 10 minutes.

A specific example of a urethane is a reaction product of polyether with toluene diisocyanate, available as Adiprene® L100 and Adiprene® L42 from Chemtura Corporation, Middlebury, Conn., United States.

In one example, the lead-free, non-toxic composite material includes between 0.5% and 50% by weight of the thermosetting polymer, based on the weight of the composite material. In another example, the composite material includes between 0.5% and 40% by weight of the thermosetting polymer, based on the weight of the composite material. In yet another example, the composite material includes between 0.5% and 35% by weight of the thermosetting polymer, based on the weight of the composite material. In a further example, the composite material includes between 0.5% and 30% by weight of the thermosetting polymer, based on the weight of the composite material. In yet a further example, the composite material includes between 0.5% and 25% by weight of the thermosetting polymer, based on the weight of the composite material. In yet another example, the composite material includes between 0.5% and 20% by weight of the thermosetting polymer, based on the weight of the composite material. In yet a further example, the composite material includes between 10% and 30% by weight of the thermosetting polymer, based on the weight of the composite material. In yet another example, the composite material includes between 10% and 25% by weight of the thermosetting polymer, based on the weight of the composite material. In a further example, the composite material includes between 10% and 20% by weight of the thermosetting polymer, based on the weight of the composite material. In yet another example, the composite material includes between 5% and 35% by weight of the thermosetting polymer, based on the weight of the composite material. In a further example, the composite material includes between 5% and 30% by weight of the thermosetting polymer, based on the weight of the composite material.

The lead-free, non-toxic composite material may also include at least one heavy particulate filler, and at least one light particulate filler or a combination thereof. Fillers are used in the composite compositions for a variety of reasons, including, but not limited to, radiation shielding, cost reduction, viscosity modification, improvement of processing, density control, altering electrical and optical properties, and control of thermal expansion, thermal conductivity, magnetic properties, flame retardancy and improvement of mechanical properties, such as impact resistance and thermal resistance.

It is contemplated that any filler may be used in the composite material described herein. The heavy particulate filler in the composite material may have a high atomic number. Examples of heavy particulate fillers include, but are not limited to tungsten, osmium, uranium, iridium, platinum, gold, molybdenum, tantalum, hafnium, thallium, palladium, ruthenium, rhodium, silver, and combinations thereof. The composite material may include one or more different heavy particulate fillers. Heavy particulate fillers utilized in the composite material may be in any form, e.g., powder form or granular form.

The composite material may contain any amount of heavy particulate filler desired. The amount of heavy particulate filler will vary depending on viscosity, processability, desired densities, desired dielectric strength, desired electric arc resistance, specific levels of radiation shield in the composite material and cost considerations.

In one example, the composite material contains between about 1% and about 99.5% by weight of the heavy particulate filler, based on the weight of the composite material.

In another example, the composite material contains between about 1% and about 95% by weight of the heavy particulate filler, based on the weight of the composite material.

In still another example, the composite material contains between about 1% and about 80% by weight of the heavy particulate filler, based on the weight of the composite material.

In still another example, the composite material contains between about 10% and about 99.5% by weight of the heavy particulate filler, based on the weight of the composite material.

In another example, the composite material contains between about 10% and about 95% by weight of the heavy particulate filler, based on the weight of the composite material.

In still another example, the composite material contains between about 10% and about 80% by weight of the heavy particulate filler, based on the weight of the composite material.

In still another example, the composite material contains between about 20% and about 99.5% by weight of the heavy particulate filler, based on the weight of the composite material.

In another example, the composite material contains between about 20% and about 95% by weight of the heavy particulate filler, based on the weight of the composite material.

In still another example, the composite material contains between about 20% and about 80% by weight of the heavy particulate filler, based on the weight of the composite material.

In still another example, the composite material contains between about 40% and about 99.5% by weight of the heavy particulate filler, based on the weight of the composite material.

In another example, the composite material contains between about 40% and about 95% by weight of the heavy particulate filler, based on the weight of the composite material.

In still another example, the composite material contains between about 40% and about 80% by weight of the heavy particulate filler, based on the weight of the composite material.

In still another example, the composite material contains between about 40% and about 70% by weight of the heavy particulate filler, based on the weight of the composite material.

In another example, the composite material contains between about 50% and about 85% by weight of the heavy particulate filler, based on the weight of the composite material.

In still another example, the composite material contains between about 50% and about 80% by weight of the heavy particulate filler, based on the weight of the composite material.

In still another example, the composite material contains about 1% to about 30% by weight of the heavy particulate filler.

In still another example, the composite material contains between about 10% and about 30% by weight of the heavy particulate filler.

In still another example, the composite material contains between about 20% and about 30% by weight of the heavy particulate filler.

Typically, the heavy particulate fillers have an average particle size between about 0.1 micron and about 200 microns. In another example, the heavy particulate fillers have an average particle size between about 0.5 micron and about 200 microns. In another example, the heavy particulate fillers have an average particle size between about 0.1 micron and about 100 microns. In a further example, the heavy particulate fillers have an average particle size between 0.5 micron and 100 microns. In yet another example, the heavy particulate filler has an average particle size between about 0.5 micron and 50 microns. In still a further example, the heavy particulate filler has an average particle size between about 1.0 micron and 15 microns.

In one example of the composite material, the heavy particulate filler is tungsten. Tungsten may be used in either granule or powder form or a combination thereof. Tungsten may be used in combination with one or more heavy particulate fillers. In another example, tungsten may be used in combination with one or more light particulate fillers. In yet a further example, tungsten may be used in combination with one or more heavy particulate fillers as well as in combination with one or more light particulate fillers. In yet a further example, tungsten may be used in combination with one or more heavy particulate fillers, with one or more light particulate fillers as well as in combination with one or more arc resistant fillers.

Examples of light particulate fillers include, but are not limited to fillers having a relatively high atomic number. Specific examples of light particulate fillers include, but are not limited to tungsten disulfide, barium, barium sulfate, barium carbonate, barium hydroxide, barium oxide, tin, tin oxide, tin dioxide, bismuth, bismuth oxide, copper, copper oxide, iodine, zirconium, zirconium dioxide, nickel, nickel oxide, and combinations thereof. It is contemplated that the composite material may contain one or more different light particulate fillers.

The composite material may contain any amount of light particulate fillers desired. The amount of light particulate filler will vary depending on viscosity, processability, desired densities, desired dielectric strength, desired electric arc resistance, specific levels of radiation shield in the composite material and cost considerations.

In one example, the composite material contains between about 1% and about 99.5% by weight of the light particulate filler, based on the weight of the composite material.

In another example, the composite material contains between about 1% and about 95% by weight of the light particulate filler, based on the weight of the composite material.

In still another example, the composite material contains between about 1% and about 80% by weight of the light particulate filler, based on the weight of the composite material.

In still another example, the composite material contains between about 10% and about 99.5% by weight of the light particulate filler, based on the weight of the composite material.

In another example, the composite material contains between about 10% and about 95% by weight of the light particulate filler, based on the weight of the composite material.

In still another example, the composite material contains between about 10% and about 80% by weight of the light particulate filler, based on the weight of the composite material.

In still another example, the composite material contains between about 20% and about 99.5% by weight of the light particulate filler, based on the weight of the composite material.

In another example, the composite material contains between about 20% and about 95% by weight of the light particulate filler, based on the weight of the composite material.

In still another example, the composite material contains between about 20% and about 80% by weight of the light particulate filler, based on the weight of the composite material.

In still another example, the composite material contains between about 40% and about 99.5% by weight of the light particulate filler, based on the weight of the composite material.

In another example, the composite material contains between about 40% and about 95% by weight of the light particulate filler, based on the weight of the composite material.

In still another example, the composite material contains between about 40% and about 80% by weight of the light particulate filler, based on the weight of the composite material.

In still another example, the composite material contains between about 40% and about 70% by weight of the light particulate filler, based on the weight of the composite material.

In another example, the composite material contains between about 50% and about 85% by weight of the light particulate filler, based on the weight of the composite material.

In yet another example, the composite material contains between about 50% and about 80% by weight of the light particulate filler, based on the weight of the composite material.

Typically, the light particulate fillers have an average particle size between about 0.5 micron and about 200 microns. In another example, the light particulate fillers have an average particle size between about 0.5 micron and about 100 microns. In yet a further example, the light particulate fillers have an average particle size between about 0.5 micron and about 50 microns. In still a further example, the light particulate fillers have an average particle size between about 1.0 micron and about 15 microns.

In one example of the composite material, the light particulate filler is barium sulfate. Barium sulfate may be used in either granule or powder form or a combination thereof. Barium sulfate may be used alone or in combination with one or more light particulate fillers. In another example, barium sulfate may be used in combination with one or more heavy particulate fillers, a specific example being barium sulfate used in combination with tungsten. In yet a further example, barium sulfate may be used in combination with one or more light particulate fillers, with one or more heavy particulate fillers as well as in combination with one or more arc resistant fillers.

In one embodiment, the composite material includes a thermosetting polymer, a heavy particulate filler and a light particulate filler. The light particulate filler may inhibit the settling of the heavy particulate fillers. In one example, the heavy particulate filler and the light particulate filler have different particle sizes. In another example, both the heavy particulate filler and the light particulate filler have the same size particles. In one example, both the heavy particulate filler and the light particulate filler have particles between 0.5 micron and 15 microns in size.

The weight ratio of heavy particulate filler to light particulate filler present in the composite material will vary between materials and between applications the material is used in. In one example, the weight ratio of heavy particulate filler to light particulate filler is in a range from about 1:80 to about 99.5:1. In another example, the weight ratio of heavy particulate filler to light particulate filler is in a range from about 20:60 to about 99.5:1. In yet another example, the weight ratio of heavy particulate filler to light particulate filler is in a range from about 30:45 to about 99.5:1. In another example, the weight ratio of heavy particulate filler to light particulate filler is in a range from about 45:30 to about 99.5:1. In another example, the weight ratio of heavy particulate filler to light particulate filler is in a range from about 55:20 to about 99.5:1. In another example, the weight ratio of heavy particulate filler to light particulate filler is in a range from about 60:15 to about 99.5:1. In another example, the weight ratio of heavy particulate filler to light particulate filler is in a range from about 64:16 to about 99.5:1. In yet another example, the weight ratio of heavy particulate filler to light particulate filler is in a range from about 72:8 to about 99.5:1. In a specific example, the weight ratio of heavy particulate filler to light particulate filler is 1:80. In another specific example, the weight ratio of heavy particulate filler to light particulate filler is 20:60. In a further example, the weight ratio of heavy particulate filler to light particulate filler is 30:45. In still another example, the weight ratio of heavy particulate filler to light particulate filler is 45:30. In another example, the weight ratio of heavy particulate filler to light particulate filler is 55:20. In yet another example, the weight ratio of heavy particulate filler to light particulate filler is 60:15. In yet another example, the weight ratio of heavy particulate filler to light particulate filler is 64:16. In another example, the weight ratio of heavy particulate filler to light particulate filler is 72:8. In still a further example, the weight ratio of heavy particulate filler to light particulate filler is 80:1. In another specific example, the weight ratio of heavy particulate filler to light particulate filler is 82:1. In a further specific example, the weight ratio of heavy particulate filler to light particulate filler is 86:1. In another specific example, the weight ratio of heavy particulate filler to light particulate filler is 90:1. In a further specific example, the weight ratio of heavy particulate filler to light particulate filler is 95:1. In still a further example, the weight ratio of heavy particulate filler to light particulate filler is 99.5:1.

In one embodiment, the composite material includes a thermosetting polymer, a heavy particulate filler, a light particulate filler and an arc resistant filler. The arc resistant filler may further improve dielectric strength and arc resistance. In one example, the arc resistant filler, the heavy particulate filler and the light particulate filler have different particle sizes. In another example, all of the arc resistant filler, the heavy particulate filler and the light particulate filler have the same size particles. In one example, all of the arc resistant filler, the heavy particulate filler, and the light particulate filler have particles between 0.1 micron and 15 microns in size. In particular embodiments, the arc resistant filler comprises between about 0.5% wt and about 70% wt of the composite materials. In other embodiments, the arc resistant filler comprises between about 5% wt and about 60% wt of the composite materials. In other embodiments, the arc resistant filler comprises between about 10% wt and about 50% wt of the composite materials. In other embodiments, the arc resistant filler comprises between about 20% wt and about 40% wt of the composite materials. In other embodiments, the arc resistant filler comprises between about 20% wt and about 30% wt of the composite materials. Of course these are exemplary percentages and the arc resistant filler may comprise any percentages between these figures, for example, about 1.5% wt, 3% wt, 5.5% wt, 12% wt, 15% wt, 18% wt, 22% wt, 25% wt, 27% wt, 31% wt, 34% wt, 36% wt, 41% wt, 44% wt, 47% wt, 51% wt, 54% wt, 56% wt of the composite materials.

In one embodiment, the composite material includes a heavy particulate filler, such as tungsten, a light particulate filler, such as barium sulfate, and an arc resistant filler, such as boron nitride; wherein the composite material has a lower level radiation shielding ranging from about 5 kV to about 50 kV. In another embodiment, the composite material includes a combination of a heavy particulate filler, such as tungsten, a light particulate filler, such as barium sulfate and an arc resistant filler, such as, boron nitride or zinc oxide or a combination of the two to produce an intermediate density composite material that targets levels of radiation energy ranging from 50 kV to about 140 kV.

In yet another embodiment, the composite material includes a combination of a heavy particulate filler, for example, tungsten, a light particulate filler, for example, barium sulfate and an arc resistant filler, for example, boron nitride or zinc oxide or a combination of the two, but have different weight ratios to produce a high density composite material that targets high levels of radiation energy ranging from 140 kV to about 300 kV.

In yet another embodiment, the composite material comprises at least one thermosetting polymer, at least one heavy particular filler, and at least one light particulate filler. This composite material can be used to manufacture any suitable article such as a lead-free, non-toxic, radiation shielding device. The thermosetting polymer is present in an amount of about 0.5 wt. % to about 50 wt. % based on the total weight of the composite material and is selected from the group consisting of epoxy resins, urethane prepolymers, phenolics, silicones, unsaturated esters, vinyl esters, melamines, and combinations thereof. The heavy particulate filler is a metal selected from the group consisting of tungsten, osmium, uranium, iridium, platinum, gold, molybdenum, tantalum, hafnium, thallium, palladium, ruthenium, rhodium, silver, and combinations of the foregoing materials. The light particulate filler is selected from the group consisting of barium, barium sulfate, barium carbonate, barium hydroxide, barium oxide, tin, tin oxide, tin dioxide, bismuth, bismuth oxide, copper, copper oxide, iodine, zirconium, zirconium dioxide, nickel, nickel oxide, and combinations of the foregoing materials.

The heavy particulate filler may be present in an amount of about 1 wt. % to about 99.5 wt. %. In another example of this embodiment, the heavy particulate filler may be present in an amount of about 1 wt. % to about 30 wt. %. In still another example of this embodiment, the heavy particulate filler may be present in an amount of about 10 wt. % to about 30 wt. %. In still another example of this embodiment, the heavy particulate filler may be present in an amount of about 20 wt. % to about 30 wt. %.

The light particulate filler may be present in an amount of about 1 wt. % to about 99.5 wt. % based on the total weight of the composite material. The ratio of the heavy particulate filler to the light particulate filler is about 1:80 to about 99.5:1.

One method of dispensing and/or manufacturing an article such as a lead-free, non-toxic, radiation shielding device (e.g., a radiation shielding device for radioactive isotopes of Xenon, Xe-133, technetium, Tc-99m, gallium citrate, Ga-67, samarium, Sm-153, thallium chloride, or Tl-201) includes the steps of forming a lead-free composite material by combining the liquid thermosetting polymer, the heavy particulate filler, and the light particulate filler and casting the lead-free composite material to produce the desired article.

In another embodiment, the composite material comprises at least one thermosetting polymer, at least one heavy particular filler, at least one light particulate filler, and an arc resistant filler, which can also be used to manufacture any suitable article such as a lead-free, non-toxic, radiation shielding device. The thermosetting polymer is present in an amount of about 0.5 wt. % to about 50 wt. % based on the total weight of the composite material and is selected from the group consisting of epoxy resins, urethane prepolymers, phenolics, silicones, unsaturated esters, vinyl esters, and melamine. The heavy particulate filler is a metal selected from the group consisting of tungsten, osmium, uranium, iridium, platinum, gold, molybdenum, tantalum, hafnium, thallium, palladium, ruthenium, rhodium, silver, and combinations of the foregoing materials. The light particulate filler is selected from the group consisting of barium, barium sulfate, barium carbonate, barium hydroxide, barium oxide, tin, tin oxide, tin dioxide, bismuth, bismuth oxide, copper, copper oxide, iodine, zirconium, zirconium dioxide, nickel, nickel oxide, and combinations of the foregoing materials.

The heavy particulate filler may be present in an amount of about 1 wt. % to about 99.5 wt. %. In another example of this embodiment, the heavy particulate filler may be present in an amount of about 1 wt. % to about 30 wt. %. In still another example of this embodiment, the heavy particulate filler may be present in an amount of about 10 wt. % to about 30 wt. %. In still another example of this embodiment, the heavy particulate filler may be present in an amount of about 20 wt. % to about 30 wt. %.

The light particulate filler may be present in an amount of about 1 wt. % to about 99.5 wt. % based on the total weight of the composite material. The ratio of the heavy particulate filler to the light particulate filler is about 1:80 to about 99.5:1.

The arc resistant filler, which is present in an amount of about 0.5 wt. % to about 70 wt. % based on the total weight of the composite material, is a metal oxide, a metalloid oxide, a metal nitride, and/or a metalloid nitride selected from the group consisting of boron nitride, boron oxide, zinc oxide, aluminum oxide, titanium oxide, magnesium oxide, iron oxide, and combinations of the foregoing materials. The ratio of the heavy particulate filler, the light particulate filler, and the arc resistant filler is about 1:80:0.5 to about 99.5:1:60.

One method of dispensing and/or manufacturing an article such as a lead-free, non-toxic, radiation shielding device (e.g., a radiation shielding device for radioactive isotopes of Xenon, Xe-133, technetium, Tc-99m, gallium citrate, Ga-67, samarium, Sm-153, thallium chloride, or Tl-201) including the arc resistant filler includes the steps of forming a lead-free composite material by combining the liquid thermosetting polymer, the heavy particulate filler, the light particulate filler, and the arc resistant filler, and casting the lead-free composite material to produce the desired article.

In one particular embodiment, one exemplary thermosetting polymer is epoxy resin, one exemplary heavy particulate filler is tungsten in powder form, and one exemplary light particulate filler is barium sulfate in powder form. Boron nitride in powder form may be the arc resistant filler. The arc resistant filler may also be the combination of boron nitride powder and zinc oxide powder.

The amounts and ratios of heavy particulate fillers, light particulate fillers and arc resistant fillers may be modified to produce composite materials that address different levels of radiation energy shielding. Likewise, the amounts and ratios of heavy particulate fillers, light particulate fillers and arc resistant fillers may be modified to improve the ease of processing, control of viscosities, densities, inhibit tungsten powder settling, improve dielectric strength and arc resistance and increase mechanical properties such as tensile strength and flexural modulus and the like.

In any of the foregoing embodiments, the composite material may also include an additive selected from a curative, a processing aid, a functional additive, a pigment, or combinations thereof. It is contemplated that the composite material may include more than one of the above-mentioned additives. Examples of curatives include, but are not limited to metaphenlenediamine (MPDA), diethylenetriamine (available as Epikure™ 3223, from Hexion Specialty Chemicals, Columbus, Ohio, United States), a blend of polyethylenepolyamines and propoxylated polyethylenepolyamines (available as Epikure™ 3290, from Hexion Specialty Chemicals, Columbus, Ohio, United States), an amine-based adduct curing agent (available as Epikure™ W Curing Agent, from Hexion Specialty Chemicals, Columbus, Ohio, United States), 4,4′ methylene-bis-(ortho-chloroaniline) (also referred to as “MBOCA” or “MOCA”), 3,5-dimethylthiotoluylenediamine (available under the trade name Ethacure 300, from Albemarle Corporation, Baton Rouge, La., United States), and the like.

Examples of processing aids include, but are not limited to anti-foaming agents such as a silicone defoamer available as Antifoam 41-B, from Synalloy Corp., Cleveland, Tenn., United States. Examples of processing aids also include plasticizers, which may reduce viscosity to allow for easier processing and molding.

Examples of functional additives include, but are not limited to flame retardants, UV stabilizers and anti-fouling agents. Functional additives may also include fumed silica, which may be used as a viscosity modifier or rheological property modifier. Fumed silica is available as CAB-O-SIL® TS-720 and CAB-O-SIL® M-5, from Cabot Corporation, Boston, Mass., United States.

Typically, the additives are present in the composite material in an amount between 0.1% and about 20% by weight, based on the weight of the composite material. In one example, the additives are present in the composite material in an amount between 0.5% to about 20% by weight, based on the weight of the composite material. In still another example, the additives are presented in an amount between about 1% and about 20% by weight based on the weight of the composite material. In a further example, the additives are present in an amount between about 5% and about 12% by weight, based on the weight of the composite material. In still a further example, the additives are present in an amount between about 7% and about 10% by weight, based on the weight of the composite material. In yet a further example, the additives are present in an amount between about 8% and about 10% by weight, based on the weight of the composite material. In still another example, the additives are present in an amount between about 8% and about 12% by weight, based on the weight of the composite material. In yet a further example, the additives are present in an amount between about 8% and about 20% by weight, based on the weight of the composite material. In another example, the additives are present in an amount between about 7% and about 20% by weight, based on the weight of the composite material.

One or more curatives may be present in the composite material in an amount between about 0.1% and about 20% by weight, based on the weight of the composite material. In one example, the curatives may be present in the composite material in an amount between about 0.5% and about 10% by weight, based on the weight of the composite material. In yet another example, the curatives may be present in the composite material in an amount between about 1% and about 5% by weight, based on the weight of the composite material. In a further example, the curatives may be present in the composite material in an amount between about 2% and about 5% by weight, based on the weight of the composite material. In yet a further example, the curatives may be present in the composite material in an amount between about 2% and about 4% by weight, based on the weight of the composite material.

One or more pigments may be present in the composite material in an amount between about 0.5% and about 5% by weight, based on the weight of the composite material. In one example, pigments may be present in the composite material in an amount between about 1% and about 5% by weight, based on the weight of the composite material. In yet another example, pigments may be present in the composite material in an amount between about 2% and about 5% by weight, based on the weight of the composite material. In a further example, pigments may be present in the composite material in an amount between about 2% and 3.0% by weight, based on the weight of the composite material. In yet a further example, pigments may be present in the composite material in an amount between about 2.0% and 3.0% by weight, based on the weight of the composite material. In yet another example, pigments may be present in the composite material in an amount between about 2% and 2.5% by weight, based on the weight of the composite material.

Anti-foaming agents may be added to the composite material in an amount between 0% and 5% by weight, based on the weight of the composite material. In one example, anti-foaming agents are present in the composite material in an amount between 0% and 5% by weight, based on the weight of the composite material. In another example, the anti-foaming agents are present in the composite material in an amount between 0% and 1% by weight, based on the weight of the composite material. However, the anti-foaming agents are usually added to the composite material in a drop-wise manner. In one example, between zero and five (0-5) drops of anti-foaming agent are added to the composite material. In another example, use between three and five (3-5) drops of anti-foaming agent is added to the composite material. In another example, 3 drops of anti-foaming agent are added to the composite material.

Various articles may be manufactured with the above-described composite material. For instance, radiation shielding articles may be manufactured from the composite materials. Examples of articles include, but are not limited to, body shielding, reactor shielding, ion implantation machine source insulators, X-ray and gamma-ray tube housings, radioisotope housings, syringe housings for radiation shield applications, and the like. The composite material disclosed herein may also be used for ballast and other weight/balancing applications as well as for energy storage. Moreover, the composite material may be used as layers or coatings on articles used in radiation shielding. The composite material may also be used to manufacture casings, containers, laminates, and other types of articles.

An article, such as a radiation shielding device, a ballast article, a weight-balancing article, or an energy storage article, may be manufactured by combining a thermosetting polymer in a liquid form with a filler selected from a heavy particulate filler, a light particulate filler, or a combination thereof, to form a composite material. In one example, if more than one filler is included in the composite material, the fillers are dry-blended and mixed prior to being mixed with a liquid thermosetting polymer. The composite material is in a liquid form and able to be poured or cast to form the desired article, such as a radiation shielding device.

Casting is a method that involves, inter alia, combining specific components in certain amounts to form a desired liquid material and pouring the liquid material, such as the disclosed composite material, into a mold to form an article. Logos and identification markings may be embedded into the article either during or after the casting process. Dimples and/or raised surfaces may be embedded into the article either during or after the casting process, or alternatively, incorporated into the mold, in an effort to decrease the surface area in contact with smooth goods, thereby further reducing friction.

In one example of casting a composite material, the thermo-setting polymer is pre-heated to a temperature between 150° Fahrenheit to 250° Fahrenheit, a curative is melted in an oven set at a temperature between 170° Fahrenheit to 190° Fahrenheit, and one or more fillers are mixed with the thermosetting polymer until a uniform mixture is obtained. Once a uniform mixture is obtained, it is de-gassed for one to five minutes by adding anti-foam agent. One or more curatives are added to the mixture and the mixture is then de-gassed for a time period between thirty seconds and five minutes. The temperature of the mixture should be maintained between 130° Fahrenheit to 230° Fahrenheit. The mixture is then cast into the mold, which is pre-heated in an oven having a temperature between 150° Fahrenheit to 250° Fahrenheit. The mixture is cured for a time period between thirty and 180 minutes, after which it is de-molded and allowed to post-cure. Post cure may be between 1 and 20 hours at a temperature between 150° Fahrenheit to 300° Fahrenheit. The parameters of the casting process may vary between different composite materials.

Alternatively, an article, such as a radiation shielding device, a ballast article, a weight-balancing article, or an energy storage article, may be manufactured by combining a thermosetting polymer in a solid form with a filler selected from a heavy particulate filler, a light particulate filler, or a combination thereof, to form a composite material. The composite material is in a solid form. The solid composite material is subjected to liquid phase sintering to form an article, such as a radiation shielding device. Liquid phase sintering involves melting the solid composite material and then subjecting the composite material to a normal cure reaction process. Specifically, liquid phase sintering occurs when the thermosetting polymer together with the curatives, processing agents and fillers are used in powdered form, are mixed or blended at ambient temperature, transferred to a preheated mold and cured under pressure. The mold temperature is set above the melting temperatures for all of the components (excluding the fillers) while allowing the chemical reaction/curing reaction to take place. The temperature is set around between 150 degrees Fahrenheit (150° F.) to 300 degrees Fahrenheit (300° F.) for 30 to 180 minutes in order to complete the chemical reaction/curing reaction, however, it is contemplated that the temperature and length of time can vary.

In one example, a non-castable composite material is used to manufacture a lead-free, non-toxic article by pre-heating a mold to a temperature between 230° Fahrenheit to 250° Fahrenheit. A solid thermo-setting polymer is mixed with a solid curative. In a composite material including two or more fillers, the fillers are combining in a separate container and mixed until uniform. The filler (or the mixture of the fillers) is then combined with the thermo-setting polymer and curative until a uniform mixture is obtained. The combining and mixing of the fillers with the thermo-setting polymer and curative may be done in a seal chamber. Once in a uniform state, the mixture is pre-heated in a press to a temperature between 150° Fahrenheit to 250° Fahrenheit. Liquid phase sintering is conducted for a time between thirty and sixty minutes, after which the mixture is de-molded and allowed to post-cure. Post cure can occur for a time period between one and sixteen hours at a temperature between 230° Fahrenheit to 300° Fahrenheit. Other parameters may be employed based on the composite material used.

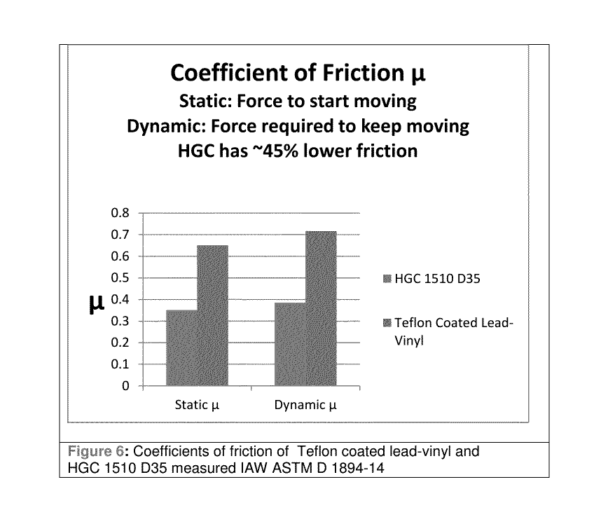

We have discovered an unexpectedly low friction, highly durable, flexible, lead-free radiation shielding curtain material. The coefficient of friction is surprisingly below that of Teflon® coated lead-vinyl. FIG. 6 shows the static and dynamic coefficients or friction of Teflon® coated lead-vinyl and HGC 1510 D35 which is one of the new materials disclosed in this invention.

The composition of a surprisingly low-coefficient of friction, highly durable, flexible, lead-free, radiation attenuating material and method for making same are disclosed. Also disclosed are a composition of self-lubricating low-coefficient of friction, highly durable, flexible, lead-free, radiation attenuating material and method for making same. In addition we disclose radiation shielding slats, strip curtains and strip curtain assemblies made from the new materials. Strip curtains made from the new material have been tested in a high speed EDS at a TSA qualified test site. Radiation shielding and mis-reads were measured using 6 lb. to 20 lb. test bags. Strip curtains made from the material disclosed in this invention were found to perform better than strip curtains made from two different lead-vinyl materials. The self-lubricating, radiation-attenuating material is composed of a high atomic number metal, a high atomic number solid lubricant and a thermoset or thermoplastic polymer and is useful for improving the wear-life, performance and safety of radiation shielding curtains positioned at the entrances and exits of X-ray scanning devices and explosive detection systems (scanners) used to screen goods, such as passenger baggage, parcels and cargo placed on or otherwise carried by airliners. Radiation shielding curtains constructed using the self-lubricating radiation attenuating material described herein decrease the friction between the baggage or cargo and the individual “slats” that comprise the radiation shielding curtain. The decreased friction lowers the abrasion caused by the passage of baggage or cargo. In addition the preferred embodiments of the new materials use tungsten as the high Z number, high density radiation shielding component. Tungsten is 5× more scratch resistant than lead (Mohs hardness: W=7.5, Pb=1.5). Tungsten resists indentation ˜55× better than lead (Brinell hardness: W=1.96 to 2.45, PB=0.038 to 0.042). The combination of lower friction and higher hardness results in increased wear-life for the curtains made with the materials of the present invention. This results in more consistent baggage flow, fewer ‘baggage dislocations’ and fewer ‘baggage jams’ caused by baggage catching on worn and damaged curtains. The increased wear-life and fewer baggage jams help maintain radiation leakage levels below regulatory limits at all times, assure consistent speed of baggage through the scanner, reduce mis-tracks and false detections attributed to poorly functioning radiation shielding curtains and totally eliminate the exposure of TSA personnel and passengers to toxic lead-dust produced as the incumbent lead-vinyl radiation shielding curtains wear out.

The following are representative examples of composite materials as described herein. Unless otherwise noted, amounts given are in weight percent (% wt.).

### EXAMPLES

TABLE 1
Composite Materials

| | Thermosetting | Heavy Particulate | Light Particulate | | Specific |
|---|---|---|---|---|---|
| Example | Polymer | Filler | Filler | Additives | Gravity |
| 1 | Liquid Epoxy Resin | Tungsten powder | Barium sulfate | Curatives, processing aids, | 1.5-3.0 |
| | 10-30% wt. | 5-30% wt | 40-70% wt. | functional additives and/or | |
| | | | | pigments | |
| | | | | 0.1-20% wt. | |
| 2 | Liquid Epoxy Resin | Tungsten powder | Barium sulfate | Curatives, processing aids, | 3.0-7.0 |
| | 5-20% wt. | 10-95% wt. | 5-70% wt | functional additives and/or | |
| | | | | pigments | |
| | | | | 0.1-20% wt. | |
| 3 | Liquid Epoxy Resin | Tungsten | Barium sulfate | Curatives, processing aids, | 2.5-6.0 |
| | 5-30% wt. | 10-95% wt. | 10-70% wt. | functional additives and/or | |
| | | | | pigments | |
| | | | | 0.1-20% wt. | |
| 4 | Solid Epoxy Resin | tungsten | Barium sulfate | Curatives, processing aids, | 2.0-4.5 |
| | 0.5-30% wt. | 5-90% wt | 10-30% wt. | functional additives and/or | |
| | | | | pigments | |
| | | | | 0.1-20% wt. | |
| 5 | Solid Epoxy Resin | Tungsten powder | Barium sulfate | Curatives, processing aids, | 4.5-12 |
| | 0.5-20% wt. | 70-99.5% wt. | 1-30% wt. | functional additives and/or | |
| | | | | pigments | |
| | | | | 0.1-20% wt. | |
| 6 | Solid Epoxy Resin | Tungsten powder | Barium sulfate | Curatives, processing aids, | 2.5-12 |
| | 0.5-30% wt. | 1-99.5% wt. | 5-99.5% wt. | functional additives and/or | |
| | | | | pigments | |
| | | | | 0.1-20% wt. | |
| 7 | Liquid Urethane | Tungsten powder | Barium sulfate | Curatives, processing aids, | 2.5-4.5 |
| | Prepolymer | 10-80% wt. | 5-70% | functional additives and/or | |
| | 10-40% wt. | | | pigments | |
| | | | | 0.1-20% wt. | |
| 8 | Liquid Urethane | Tungsten powder | Barium sulfate | Curatives, processing aids, | 2.0-3.5 |
| | Prepolymer | 10-70% wt | 5-70% wt. | functional additives and/or | |
| | 10-40% wt. | | | pigments | |
| | | | | 0.1-20% wt. | |
| 9 | Liquid Urethane | Tungsten powder | Barium sulfate | Curatives, processing aids, | 2.0-4.5 |
| | Prepolymer | 5-80% wt. | 5-70% wt. | functional additives and/or | |
| | 10-20% wt. | | | pigments | |
| | | | | 0.1-20% wt. | |
| 10 | Liquid Urethane | Tungsten powder | Stainless steel | Curatives, processing aids, | 2.0-4.5 |
| | Prepolymer | 10-70% wt | powder | functional additives and/or | |
| | 10-20% wt. | | 40-80% wt. | pigments | |
| | | | | 0.1-20% wt. | |
| 11 | Liquid Epoxy Resin | Tungsten powder | Stainless steel | Curatives, processing aids, | 3.0-5.0 |
| | 10-20% wt. | 20-70% wt | powder | functional additives and/or | |
| | | | 50-80% wt. | pigments | |
| | | | | 0.1-20% wt. | |

### Example 12

A composite material having the following components is made (4210-d26) according to casting processes disclosed herein:
21.75% Epon™ 8280 epoxy resin, available from Hexion
3.25% MPDA curative, available from DuPont
75.0% CIMBAR XF barium sulfate, available from Potters Industries Inc., Malvern, Pa., United States
3 to 5 drops of anti-foaming agent
   The composite material yields a density of 2.6 grams per cubic centimeter and absorbs or blocks 41.3% of X-ray radiation energy exposed to a 140 kVp X-ray radiation source. A pure lead material having an identical thickness absorbs or blocks 96.3% of X-ray radiation at 140 kVp X-ray radiation source.
   The composite material has the following properties:
95 D hardness
0.4 ft-lb/in notched izod impact strength
4190 psi tensile strength
0.5% elongation
9190 psi flexural strength
1340 ksi flexural modulus
7.1×10̂15 ohm-cm volume resistivity
0.449 W/m k thermal conductivity
5.86 dielectric constant
384 V/mil dielectric strength
   This example shows that barium sulfate has excellent dielectric strength but poor X-ray radiation shielding capability when being tested at a 140 kVp X-ray radiation source.

### Example 13

A lead & lead tetraoxide filled epoxy resin based composite material is made (4910-90D HD) by a liquid casting process. The composite material has a specific gravity of 4.29 and it is commercially available. The composite material has the following properties:
95 D hardness
0.46 ft-lb/in notched izod impact strength
4500 psi tensile strength
1.0% elongation
9190 psi flexural strength
1340 ksi flexural modulus
10̂15 ohm-cm volume resistivity
0.5567 W/m k thermal conductivity
6.4 dielectric constant
215 V/mil dielectric strength
78 seconds arc resistance
   This composite material absorbs or blocks approximately about 94.0% to about 96.0% X-ray radiation energy with a test sheet thickness of 0.25 inch when being tested at a 76 kVp X-ray radiation source.

### Example 14

A composite material having the following components is made (4210-d35, Lot#081009-01) according to casting processes disclosed herein:
50.0% 1.57 micron tungsten powder, available as C6-649 from Buffalo Tungsten Inc., Depew, N.Y., United States.
18.7% Epon™ 8280 epoxy resin, available from Hexion
2.8% MPDA curative, available from DuPont
27.5% 200 barium sulfate available from Potters Industries Inc.
3 to 5 drops of anti-foaming agent
   The composite material yields a density of 3.635 grams per cubic centimeter and absorbs or blocks approximately about 94.0% X-ray radiation energy, which has a similar radiation shielding performance as lead & lead tetraoxide filled composite materials in Example 13. When being tested for X-ray radiation shielding, both composite materials were identical in thickness (0.25 inch) and exposed to a 76 kVp X-ray radiation source. However, this composite material has 23 second arc resistance tested according to ASTM D-495 & UL 746A. The arc resistance is much lower than that of the composite material in Example 13. Thus, improvement of arc resistance is necessary.

### Example 15

A composite material having the following components is made (4210-d35, Lot#080609-01) according to casting processes disclosed herein to improve arc resistance:
39.02% 3.62 micron tungsten powder, available as WS-139 from Buffalo Tungsten Inc., Depew, N.Y., United States.
18.88% Epon™ 8280 epoxy resin, available from Hexion
2.57% MPDA curative, available from DuPont
21.95% barium sulfate 200 available from Potters Industries Inc.
17.56% zinc oxide Cerox-506, available from Horsehead Corp., Monaca, Pa.
3 to 5 drops of anti-foaming agent
   The composite material yields a density of 3.4 grams per cubic centimeter and absorbs or blocks approximately about 94.0% X-ray radiation energy when exposed to a 76 kVp X-ray radiation source, which is the same as that of the composite material in Example 14, but has 146 seconds arc resistance tested according to ASTM D-495 & UL 746A. In comparison with the composite material in Example 14, the arc resistance has been improved by approximately 535% at approximately the same specific gravity. The arc resistance of the composite material in Example 15 is also much better than that in Example 13, about 87% better.

### Example 16

A composite material having the following components is made (4210-d35, Lot#080609-02) according to casting processes disclosed herein further to improve arc resistance:
40% 3.62 micron tungsten powder, available as WS-139 from Buffalo Tungsten Inc., Depew, N.Y., United States.
18.5% Epon™ 8280 epoxy resin, available from Hexion
2.5% MPDA curative, available from DuPont
22% barium sulfate 200 available from Potters Industries Inc.
14.5% 2 micron zinc oxide Cerox-506, available from Horsehead Corp., Monaca, Pa.
2.5% 3-5 micron boron nitride Grade ZG, available from ZYP Coatings, Oak Ridge, Tenn.
3 to 5 drops of anti-foaming agent
   The composite material yields a density of 3.4 grams per cubic centimeter and absorbs or blocks approximately about 94.0% X-ray radiation energy when exposed to a 76 kVp X-ray radiation source, which is the same as that of the composite material in Example 14, but has 182 seconds of arc resistance according to ASTM D-495 & UL 746A. This composite material, when compared with the composite material in Example 14, has improved arc resistance of approximately 691%. When compared with the lead & lead tetraoxide filled composite material in Example 13, the arc resistance improved by about 133%. Furthermore, substituting 2.5 wt % zinc oxide powder by boron nitride powder from Example 15 further improves electric arc resistance of the composite material by about 25%.

### Example 17

A composite material having the following components is made (4210-d35, Lot#082709-02) according to casting processes disclosed herein further to improve arc resistance:
50% 3.62 micron tungsten powder, available as WS-139 from Buffalo Tungsten Inc., Depew, N.Y., United States.
18.7% Epon™ 8280 epoxy resin, available from Hexion
2.8% MPDA curative, available from DuPont
10% barium sulfate 200 available from Potters Industries Inc.
15% 2 micron zinc oxide Cerox-506, available from Horsehead Corp., Monaca, Pa.
2.5% 3-5 micron boron nitride Grade ZG, available from ZYP Coatings, Oak Ridge, Tenn.
3 to 5 drops of anti-foaming agent
   The composite material yields a density of 3.645 grams per cubic centimeter and absorbs or blocks approximately about 92.0% X-ray radiation energy when exposed to a 140 kVp X-ray radiation source, which is the same as that of the composite material in Example 14, but has 172 seconds arc resistance tested according to ASTM D-495 & UL 746A. This composite material, when compared with the composite material in Example 14, has improved arc resistance by about 648%. When compared with the lead & lead tetraoxide filled composite material in Example 13, the arc resistance improved by about 120%.

Absorption (or blockage) of X-ray radiation is determined by targeting an X-ray beam at the material, which is placed approximately fifty (50) inches away from the source of the X-ray radiation. X-ray film is placed underneath the material being tested. X-ray radiation not absorbed or blocked by the material is measured on the X-ray film.

As was discovered in the invention two composite materials having a same specific gravity may have equivalent radiation shielding performance when exposed to a relatively low radiation energy level, for example, a 76 kVp X-ray radiation source. However, they may show different radiation shielding performances at relatively high radiation energy levels, for instance, a 140 kVp X-ray radiation source. This is because the two composite materials may be comprised of different types of fillers, different particles, different filler ratios (if more than one type of fillers is used), and different chemical treatment of fillers.

### Example 18

A composite material is made with the following components according to liquid phase sintering processes disclosed herein:
96.0% 1.38 micron tungsten powder, C5-531, available from Buffalo Tungsten Inc.
3.8% Epon™ 3002 solid epoxy resin, available from Hexion
0.2% MPDA curative, available from DuPont
   The composite material yields a density of 10.1 grams per cubic centimeter.

Unless otherwise specified, all ranges disclosed herein are inclusive and combinable at the end points and all intermediate points therein. The terms “first,” “second,” “third” and the like, herein do not denote any order, sequence, quantity, or importance, but rather are used to distinguish one element from another. The terms “a” and “an” herein do not denote a limitation of quantity, but rather denote the presence of at least one of the referenced item. All numerals modified by “about” are inclusive of the precise numeric value unless otherwise specified.

### Example 19

A composite material having a thickness of 0.025 to 0.250 inches was made according to a casting process disclosed herein and includes the following components:
74%: 6.00 to 9.99 micron tungsten powder with an apparent density of 50-90 g/in³ or 3.05 to 5.49 g/cm³, available as C20 from Buffalo Tungsten, Depew, N.Y.
21% Adiprene L 100: 2, 4 Diisocyanato-1-methylbenzene, polytetramethylene glycol polymer 4.17% NCO, available from Chemtura, Middlebury, Conn.
2.1% Ethacure: Di (methylthio) toluenediamine (DMTDA) available from Chemtura
2.9% Benzoflex 9-88 SG: Plasticizer, a proprietary blend of benzoate esters available from Eastman Chemical Kingsport, Tenn.

Adiprene L100, 559.4 g, was blanketed with argon and sealed in a high density polyethylene (HDPE) container and C20 Tungsten, 1973 g, sealed in a HDPE container were heated in an oven at 54.4° C. to 60° C. overnight.

The interior of a single cavity, aluminum mold measuring 12 inches×37.375 inches×0.08 inches weighing 52 kg was thoroughly cleaned with acetone solvent wash if necessary to remove baked on silicone, compressed air to dislodge flash, wiped with clean lint free rag and sprayed with Stoner E236 silicone spray, placed in a heated oven and heated at 98.9° C. overnight.

After heating overnight the mold was removed from the 98.9° C. oven and placed in an autoclave set at 98.9° C. The C20 tungsten powder was removed from the 54.4° C. to 60° C. oven and 1973 grams of it were weighed into a 2515 ml white, flat bottomed, polypropylene container (Berry, T60785CP-1). The container was sealed with a lid and returned to the oven at 54.4° C. to 60° C.

The Adiprene L-100 was removed from the oven, and 559.4 grams of it were weighed into a white flat bottomed 4920 ml HDPE reaction vessel (Berry T811166-5).

77.2 grams of Benzoflex (Benzoflex at ambient temperature) was added to the Adiprene L-100 in the 4.9 L Berry reaction vessel. The Adiprene was at approximately 40° C. to 45° C. Two drops Antifoam 41-B, silicone defoamer, were added to the Adiprene L-100/Benzoflex mixture and mixed thoroughly with a flat aluminum stirring stick. The pre-weighed container of C20 tungsten was removed from the 54.4° C. to 60° C. oven and added slowly in 4 to 5 increments, with stirring to the Adiprene/Benzoflex solution. The resulting mixture was thoroughly stirred after each incremental addition of tungsten with the metal stirring stick, scraping the walls and the bottom of the container while mixing. After all the tungsten had been mixed into the Adiprene/Benzoflex solution, the polyethylene reaction vessel was placed on a on drill type mixer set at 470 rpm's and the agitator slowly lowered into the mixture so that it was ˜5 mm from the bottom of the container. Agitation was started and continued for a minimum of 3 minutes allowing the mixing blade to occasionally come into contact with the side walls of the container. Agitation was stopped periodically and the side walls and bottom of the container scraped with the metal stirring stick at least twice during the 3 minute mix cycle.

When the 3 minute mix cycle was complete the agitator blade was raised to just above the surface of the mixture before shutting off the mixer.

The container was placed into a vacuum chamber and degassed five times at 28 inches Hg. The contents were then held under vacuum of for 1 minute until all bubbling had subsided.

The polyethylene reaction vessel was removed from the vacuum chamber and 56.4 g of Ethacure, at ambient temperature, were added to the tungsten, Adiprene L-100, Benzoflex and Antifoam 41-B mixture.

The mixture was stirred initially with the Al metal stirrer scraping the walls and the bottom of the container while mixing to incorporate the Ethacure into the mixture before beginning mechanical agitation.

The polyethylene reaction vessel was placed on the base of the drill type mixer (set at 470 rpm's) and the agitator was lowered into the mixture so that the bottom of the mixing blade was ˜5 mm from the bottom of the vessel. The agitator was started and mixing continued for a minimum of 1 minute allowing the mixing blade to occasionally come into contact with the side walls of the reaction vessel. Agitation was stopped twice during the one minute mix time to scrape the side walls and bottom of the container with the flat metal stirring stick.

When the 1 minute mix cycle was complete the agitator blade was raised to just above the surface of the mixture before shutting off the mixer. The polyethylene reaction vessel was placed into the vacuum chamber and degassed at 28 inches Hg. The contents were held under vacuum at 28 inches Hg for 60 seconds after broken.

During the 60 second hold the mold and plug mold were removed from the autoclave in preparation for the pour.

The vacuum chamber was allowed to equilibrate to atmospheric pressure and the polyethylene reaction vessel was removed from the vacuum chamber. The mold was opened and the contents of the reaction vessel were poured into the mold and the mold plugs were filled (Note: Mold plugs are for density measurements).

The mold was closed and the hinged cover secured with three large C-clamps. One clamp was located on each side near the top of the mold near the side rail stops. The 0.08″ spacer was positioned near the center top opening and secured with one C-clamp.

The mold was placed back into the 98.9° C. autoclave. The autoclave was sealed and pressurized to 80 psi minimum with compressed air and cured for a minimum of 45 minutes at full pressure. The autoclave was vented upon completion of the 45 minute cure cycle and the mold rolled out of the autoclave using the rail cart. The mold was opened immediately and the part removed and placed on a table for labeling All demolded pieces were labelled with the lot number assigned as the date of the pour followed by the time of the pour; i.e. 092314 0700.

The mold was cleaned with compressed air to remove flash and clean lint free rag sprayed with Stoner silicone spray E 236, and placed back into the 98.9° C. autoclave.

The demolded part and the plugs were placed into a 98.9° C. oven for a minimum of 16 hours (post cure). The time that the parts were demolded was recorded and the parts placed into the post cure oven.

The parts and test plugs were removed from the post-cure oven and allowed to cool at ambient temperature. Once the parts were cooled, they were moved to the proper staging area for machining. Density measurements on the plugs were conducted using a Mettler Toledo XS 104 and results recorded.

This process resulted in a material having a density 3.53 g/mm³.

A similar processes were repeated but with a higher % of Benzoflex plasticizer in order to make a more flexible product.

### Example 20

A composite material having a thickness of 0.025 to 0.250 inches was made according to a casting process disclosed herein and includes the following components:
56% 6.00 to 9.99 micron tungsten powder with an apparent density of 50-90 g/in³ or 3.05 to 5.49 g/cm³, available as C20 from Buffalo Tungsten, Depew, N.Y.
30.84% Adiprene L 100: 2, 4 Diisocyanato-1-methylbenzene, polytetramethylene glycol polymer 4.24% NCO, available from Chemtura, Middlebury, Conn.
3.16% Ethacure: Di (methylthio) toluenediamine (DMTDA) available from Chemtura
10.0% Benzoflex 9-88 SG: Plasticizer, a proprietary blend of benzoate esters available from Eastman Chemical, Kingsport, Tenn.
   This composition was subjected to cast process similar to that described in Example 19 and yielded a material having a density of 2.2 g/mm³

### Example 21

A composite material having an increased flexibility thickness of 0.025 to 0.250 inches was made according to a casting process disclosed herein and includes the following components:
74% 6.00 to 9.99 micron tungsten powder with an apparent density of 50-90 g/in³ or 3.05 to 5.49 g/cm³, available as C20 from Buffalo Tungsten, Depew, N.Y.
18.14% Adiprene L 100: 2, 4 Diisocyanato-1-methylbenzene, polytetramethylene glycol polymer 4.24% NCO, available from Chemtura, Middlebury, Conn.
1.86% Ethacure: Di (methylthio) toluenediamine (DMTDA) available from Chemtura
6.0% Benzoflex 9-88 SG: Plasticizer, a proprietary blend of benzoate esters available from Eastman Chemical Kingsport, Tenn.
   This composition was subjected to cast process similar to that described in Example 19 and yielded a material having a density of 3.5 g/mm³. This material was more flexible than the similar density product made according to Example 19.

### Example 22

A composite material having an increased flexibility thickness of 0.025 to 0.250 inches was made according to a casting process disclosed herein and includes the following components:
74% 6.00 to 9.99 micron tungsten powder with an apparent density of 50-90 g/in³ or 3.05 to 5.49 g/cm³, available as C20 from Buffalo Tungsten, Depew, N.Y.
14.51% Adiprene L 100: 2, 4 Diisocyanato-1-methylbenzene, polytetramethylene glycol polymer 4.24% NCO, available from Chemtura, Middlebury, Conn.
1.49% Ethacure: Di (methylthio) toluenediamine (DMTDA) available from Chemtura
10.0% Benzoflex 9-88 SG: Plasticizer, a proprietary blend of benzoate esters available from Eastman Chemical, Kingsport, Tenn.
   This composition was subjected to cast process similar to that described in Example 19 and yielded a material having a density of 3.5 g/mm³. This material was more flexible than the similar density product made according to Example 19.

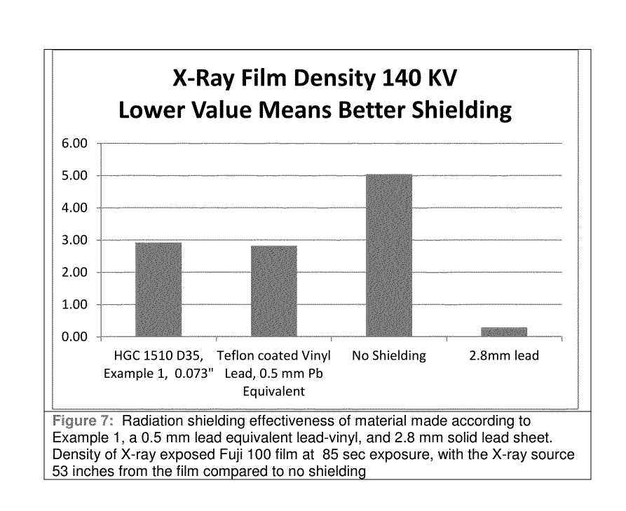

FIG. 7, shows the results of radiation shielding measurement at 140 keV on the radiation attenuating material made according to Example 19, compared to Teflon® coated lead-vinyl material having a radiation attenuating performance equivalent to 0.5 mm lead sheet.

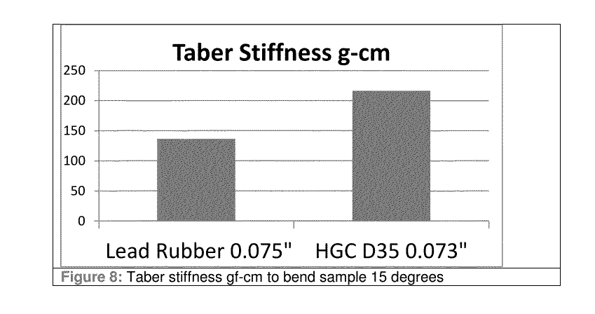

FIG. 8, shows Taber stiffness, the gf-cm required to deflect a 1.5 inch×2.75 inch sample of material 15 degrees. Examples 20, 21 and 22 were designed to produce more flexible materials.

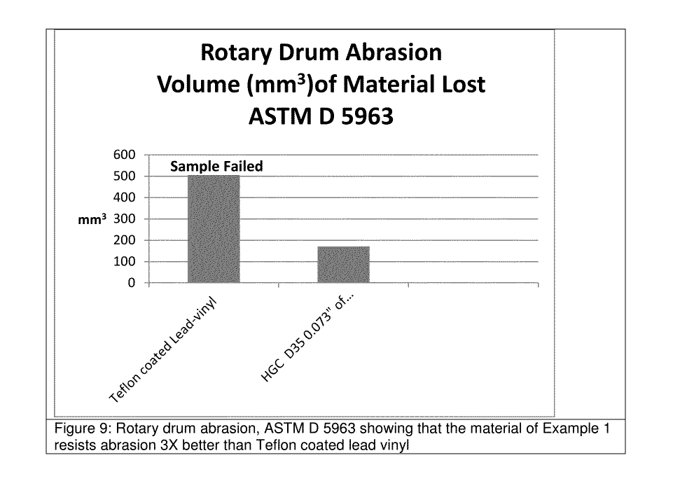

FIG. 9 graphically demonstrates the greatly improved abrasion resistance of the radiation attenuating material made according to Example 19 compared to Teflon coated lead-vinyl. The material of Example 19 resists abrasion 3X better than the lead-vinyl.

Other brands of 2, 4 Diisocyanato-1-methylbenzene, polytetramethylene glycol polymer having varying % NCO could be substituted for Adiprene L 100.

Other thermosetting polymers selected from the group comprising other polyurethanes, silicones, unsaturated esters and combinations thereof could also be employed.

High atomic number metals and compounds could be selected from the group consisting of tungsten, osmium, uranium, iridium, platinum, gold, molybdenum, tantalum, lead, bismuth, barium sulfate, iodine, zirconium, nickel, stainless steel, aluminum, tungsten disulfide molybdenum disulfide and combinations thereof could be used.

Tungsten from different conflict free sources could be used.

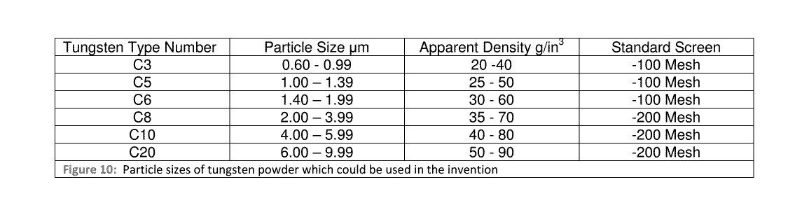

Various particle sizes of tungsten and other metals could be employed such as those shown in FIG. 10.

### Example 23

Preparation and testing of radiation attenuating slats in radiation shielding strip curtains in an Explosive Detection System.

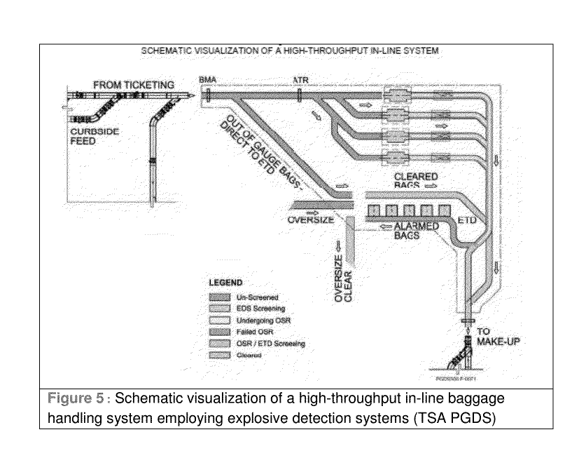

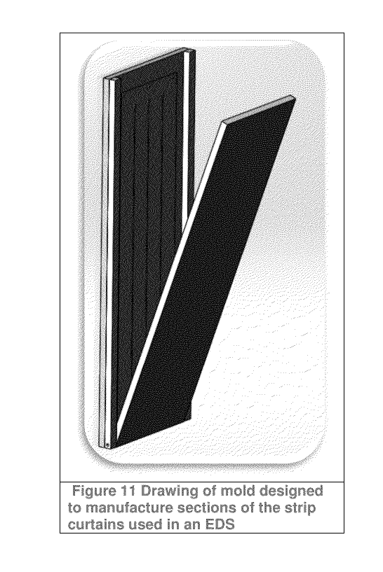

Sixty-four sections of strip curtains were made from material fabricated as described in Example 19. Each section of the radiation shielding strip curtain consisted of four slats of radiation material as depicted in FIG. 11. Testing was conducted under non-disclosure agreements at a TSA qualified independent test facility similar to that shown schematically in FIG. 5. Four sections each consisting of four slats were used in each of row of two different configurations of strip curtains at both the entrance and exit of the high speed EDS. In one configuration eight rows of curtains were used at both the entrance and exit of the EDS. In the other configuration five rows of curtains were used at the entrance and exit of the EDS. The five row arrangement was selected for final testing. In addition to the material made according to Example 19 two other competitive materials both lead-vinyl were tested at concurrently by the independent test facility.

Pieces of test baggage weighing six to twenty pounds were used to challenge the radiation shielding strip curtains made of each of the three different test materials. The test bags were positioned on the input conveyor so as to strike the face of leading strip curtain at a 0, 45 or 90 degree orientation. In a 0 degree orientation the long axis of the bag is parallel to the direction of movement of the conveyor. In a 90 degree orientation the long axis of the bag is perpendicular to the direction of movement of the conveyor.

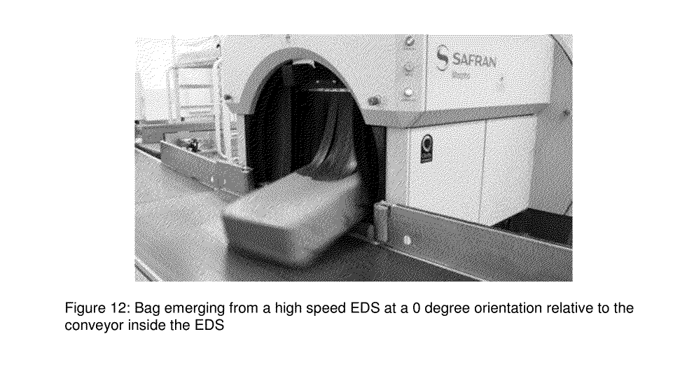

FIG. 12, for example shows a bag emerging from an EDS at a 0 degree orientation relative to the conveyor inside the EDS. In this baggage handling system (BHS) the bag is transferred to a receiving conveyor moving orthogonally to the conveyor inside the EDS. Once on the receiving conveyor the long axis of the bag will be oriented at 90 degrees relative to the direction of movement of the receiving conveyor. In the high throughput BHS shown in FIG. 5 the conveyor at the exit of the EDS moves in the same direction as the conveyor inside the EDS.

During the test radiation exposure was measured as required by 21CFR1020.4.0. When radiation strip curtains made of the material prepared as described in Example 19 were tested, at no time during the test did the radiation exposure exceed the 0.5 milliroentgen/hr limit. Furthermore there were far fewer “mis-reads” such as false detections when the curtains were made from the Example 19 material than when the curtains were made from lead-vinyl. Curtains made of the Example 19 performed substantially better than either of the lead-vinyl curtains, showed no signs of wear and had far fewer incidences of baggage dislocation. The recommendation has been made by the OEM of the EDS to replace all lead-vinyl curtains, in all of their EDS and X-ray inspection systems with material made according to Example 19. Based on our observations of the test we believe that we could improve the performance of the Example 19 material if it were more flexible. In order to increase the flexibility we made and are testing materials with a higher level of plasticizer as described in Examples 20, 21 and 22.

While benzoate ester plasticizer is the preferred embodiment other plasticizers could also be used. Plasticizers could be selected from groups consisting of dicarboxylic/tricarboxylic ester-based plasticizers: such as bis(2-ethylhexyl) phthalate (DEHP), diisononyl phthalate (DINP), di-n-butyl phthalate (DnBP, DBP), butyl benzyl phthalate (BBzP), diisodecyl phthalate (DIDP), dioctyl phthalate (DOP or DnOP), diisooctyl phthalate (DIOP), diethyl phthalate (DEP), diisobutyl phthalate (DIBP), di-n-hexyl phthalate; trimellitates: trimethyl trimellitate (TMTM), tri-(2-ethylhexyl) trimellitate (TEHTM-MG), tri-(n-octyl,n-decyl) trimellitate (ATM), tri-(heptyl,nonyl) trimellitate (LTM), n-octyl trimellitate (OTM); adipates, sebacates, maleates: bis(2-ethylhexyl)adipate (DEHA), dimethyl adipate (DMAD), monomethyl adipate (MMAD), dioctyl adipate (DOA), dibutyl sebacate (DBS), dibutyl maleate (DBM), diisobutyl maleate (DIBM); other benzoates Benzoflex: 2-45, 9-88, 50, 131, 181, 284, 352, 354, 1046; terephthalates: dioctyl terephthalate/DEHT (Eastman 168); 1,2-Cyclohexane dicarboxylic acid diisononyl ester (DINCH); Epoxidized vegetable oils; alkyl sulphonic acid phenyl ester (ASE); Sulfonamides: N-ethyl toluene sulfonamide (o/p ETSA), ortho and para isomers; N-(2-hydroxypropyl) benzene sulfonamide (HP BSA), N-(n-butyl) benzene sulfonamide (BBSA-NBBS); Organophosphates: tricresyl phosphate (TCP), tributyl phosphate (TBP); glycols/polyethers: triethylene glycol dihexanoate (3G6, 3GH), tetraethylene glycol diheptanoate (4G7); polymeric plasticizers; polybutene; biodegradable plasticizers: acetylated monoglycerides; these can be used as food additives; alkyl citrates: triethyl citrate (TEC), acetyl triethyl citrate (ATEC), tributyl citrate (TBC), acetyl tributyl citrate (ATBC), trioctyl citrate (TOC), acetyl trioctyl citrate (ATOC), trihexyl citrate (THC), acetyl trihexyl citrate (ATHC), butyryl trihexyl citrate (BTHC, trihexyl o-butyryl citrate), trimethyl citrate (TMC).

### Example 24

A composite material having an increased flexibility thickness of 0.025 to 0.250 inches is made according to a casting process disclosed herein and includes the following components:
64% 6.00 to 9.99 micron tungsten powder with an apparent density of 50-90 g/in³ or 3.05 to 5.49 g/cm³, available as C20 from Buffalo Tungsten, Depew, N.Y.
10% 0.6 μm tungsten disulfide available as MK-WS2-06 from MK IMPEX, Mississauga, Ontario, Canada
18.14% Adiprene L 100: 2, 4 Diisocyanato-1-methylbenzene, polytetramethylene glycol polymer 4.24% NCO, available from Chemtura, Middlebury, Conn.
1.86% Ethacure: Di (methylthio) toluenediamine (DMTDA) available from Chemtura
6.0% Benzoflex 9-88 SG: Plasticizer, a proprietary blend of benzoate esters available from Eastman Chemical Kingsport, Tenn.
   This composition is subjected to cast process similar to that described in Example 19 and will result in a material having a density of ˜3.0 g/mm³.

A self-lubricating, radiation attenuating composite material demonstrates, self-replenishing low coefficient of friction throughout the wear-life of the material.

The self-lubricating, radiation attenuating composite material could be formed into thin strips between 0.025 inches and 0.250 inches or greater thick, each having a length greater than its width and are useful as “slats” in radiation attenuating curtains at the entrances and exits of X-ray scanners and explosive detection systems used to screen passenger baggage and cargo carried on airliners.

The self-lubricating, radiation attenuating composite material consists of high atomic number metal, a solid material with self-lubricating capability and a polymeric binder: Thermosetting polymer binders can be selected from the group comprising other polyurethanes, silicones, unsaturated esters and combinations thereof.

High atomic number metals and compounds could be selected from the group consisting of tungsten, osmium, uranium, iridium, platinum, gold, molybdenum, thallium, hafnium, tantalum, lead, bismuth, barium sulfate, iodine, zirconium, nickel, rhenium, stainless steel, aluminum, tungsten disulfide molybdenum disulfide and combinations thereof could be used.

A solid material with self-lubricating capabilities using a solid lubricant selected from a group consisting of: lamellar solids: such as MoS₂, WS₂, hexagonal boron nitride (HBN), graphite, graphite fluoride, H₃BO₃, GaSe, GaS, SnSe; soft metals such as Ag, Pb, Au, In, Sn; mixed oxides such as CuO—Re₂O₇, CuO—MoO₃, PbO—B₂O₃, CoO—MoO₃, Cs₂O—MoO₃, NiO—MoO₃, Cs₂O—SiO₂; single oxides such as B₂O₃, Re₂O₇, MoO₃, TiO₂, ZnO; halides and sulfates of alkaline earth metals such as CaF₂, BaF₂, SrF₂, CaSO₄, BaSO₄, SrSO₄; carbon-based solids such as diamond, diamond-like carbon, glassy carbon, hollow carbon nanotubes, Fullerenes, carbon-carbon and carbon-graphite-based composites; organic materials and polymers such as zinc-stearite, waxes, soaps, PTFE; bulk or thick-film (>50 μm) composites such as metal-, polymer-, and ceramic-matrix composites consisting of graphite, WS₂, MoS₂, Ag, CaF₂, BaF₂; thin-film (<50 μm) composites such as electroplated Ni and Cr films consisting of PTFE, graphite, diamond, B₄C particles as lubricants, nanocomposite or multilayer coatings consisting of MoS₂, Ti.

The polymeric binder can be selected from a group consisting of thermosetting polymers such as epoxy resins, silicones, unsaturated polyesters, vinyl polyesters, polyimides, bismaleimides, cyanate esters, polyurethanes and combinations thereof.

The polymeric binder could be selected from a group consisting of thermoplastic polymers such as polyethylene, polypropylene, poly-dimethyleneterephthalate, poly-trimethyleneterephthalate, polyamides (nylons), polysulphones, polyphenylene sulphide, polycarbonate, polyether sulphone, polyetheramide, polyimides, polyamide-imide, polyether ether ketone, thermoplastic elastomers such as Hytrel®, Arnitel®, Engage®, Dryflex®, Kraton®, thermoplastic polyurethanes, styrenic block copolymers.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A radiation barrier for a system used to inspect goods moving along a conveyor, the radiation barrier comprising:
a flexible elongated strip to be affixed at its upper end above the conveyor, said strip consisting of:
a thermoplastic polymer;
particles of tungsten having a size range of 6.00 to 9.99 microns, the particles of tungsten suspended throughout said polymer; and
tungsten disulfide,
said flexible elongated strip substantially reducing passage of radiation while having wear resistance to reduce erosion of its surface and having flexibility and coefficient of friction to reduce displacement of the conveyed goods in directions lateral to movement of the conveyor.

2. A radiation barrier for a system used to inspect goods moving along a conveyor, the radiation barrier comprising:
a flexible elongated strip to be affixed at its upper end above the conveyor, said strip consisting of:
a thermosetting polymer;
particles of tungsten suspended throughout said polymer, the particles of tungsten are present in an amount of 56% to 74% by weight based on a total weight of the flexible elongated strip; and
tungsten disulfide,
said flexible elongated strip substantially reducing passage of radiation while having wear resistance to reduce erosion of its surface and having flexibility and coefficient of friction to reduce displacement of the conveyed goods in directions lateral to movement of the conveyor.

3. The radiation barrier system of claim 1, wherein the flexible elongated strip has a thickness of about 0.01 inch to about 1.00 inch.

4. The radiation barrier system of claim 3, wherein the flexible elongated strip has a thickness of about 0.025 inch and about 0.500 inch.

5. The radiation barrier system of claim 4, wherein the flexible elongated strip has a thickness of about 0.051 inch to about 0.250 inch.

6. The radiation barrier system of claim 1, wherein the flexible elongated strip is manufactured by one of a casting process and an extrusion process.

7. The radiation barrier system of claim 2, wherein the flexible elongated strip has a thickness of about 0.01 inch to about 1.00 inch.

8. The radiation barrier system of claim 7, wherein the flexible elongated strip has a thickness of about 0.025 inch and about 0.500 inch.

9. The radiation barrier system of claim 8, wherein the flexible elongated strip has a thickness of about 0.051 inch to about 0.250 inch.

10. The radiation barrier system of claim 2, wherein the flexible elongated strip is manufactured by one of a casting process and an extrusion process.

11. The radiation barrier system of claim 1, wherein the particles of tungsten are present in an amount of 56% to 74% by weight based on a total weight of the flexible elongated strip.

12. The radiation barrier system of claim 2, wherein the particles of tungsten have a size range of 6.00 to 9.99 microns.

13. The radiation barrier system of claim 1, wherein the tungsten disulfide is present in an amount of 10% by weight based on a total weight of the flexible elongated strip.

14. The radiation barrier system of claim 2, wherein the tungsten disulfide is present in an amount of 10% by weight based on a total weight of the flexible elongated strip.
